(19) United States
(12) Patent Application Publication
(10) Pub. No.: US 2023/0342590 A1
(43) Pub. Date: Oct. 26, 2023

(54) ACCESS NETWORKS WITH MACHINE LEARNING

(71) Applicant: DeepSig Inc., Arlington, VA (US)

(72) Inventors: Timothy James O'Shea, Arlington, VA (US); Johnathan Corgan, San Jose, CA (US); Nitin Nair, Arlington, VA (US); Nathan West, Washington, DC (US); James Shea, Arlington, VA (US); Timothy Newman, Edgewater, MD (US)

(21) Appl. No.: 18/139,126

(22) Filed: Apr. 25, 2023

Related U.S. Application Data
(60) Provisional application No. 63/334,545, filed on Apr. 25, 2022.

(51) Int. Cl. G06N 3/045; G06N 3/08; H04L 25/02; H04L 27/26

(52) U.S. Cl. CPC G06N 3/045; G06N 3/08; H04L 25/0254; H04L 27/2649

(57) ABSTRACT

A method includes obtaining samples of radio-frequency (RF) uplink data signals received wirelessly at a radio unit of a radio access network, the RF uplink data signals including a first RF uplink data signal received from a user device; providing the samples of the RF uplink data signals as input to at least one machine learning model; in response to providing the samples of the RF uplink data signals as input to the at least one machine learning model, obtaining based on an output of the at least one machine learning model, recovered data of the RF uplink data signals; and sending the recovered data of the RF uplink signals to a destination device.

### CROSS-REFERENCE TO RELATED APPLICATIONS

This application claims the benefit of U.S. Provisional Patent Application No. 63/334,545, filed Apr. 25, 2022, the entirety of which is incorporated herein by reference.

### FIELD OF THE DISCLOSURE

The present disclosure relates to signal processing and network control in communications systems.

### BACKGROUND

Examples of communications systems include radio access networks (RANs), small communications systems such as small-cell networks and Wi-Fi access point-based networks, and other network types. Radio frequency (RF) signals can be analyzed to obtain information about the network environment and extract data from the signals.

### SUMMARY

Some aspects of this disclosure describe a method. The method includes obtaining samples of radio-frequency (RF) uplink data signals received wirelessly at a radio unit of a radio access network; providing the samples of the RF uplink data signals as input to at least one machine learning model; in response to providing the samples of the RF uplink data signals as input to the at least one machine learning model, obtaining, based on an output of the at least one machine learning model, recovered data of the RF uplink data signals; and sending the recovered data of the RF uplink signals to a destination device.

This and other described methods can have one or more of at least the following characteristics.

In some implementations, sending the recovered data of the RF uplink signals to the destination device includes sending the recovered data of the RF uplink signals to one or more computer systems external to the radio access network.

In some implementations, the method includes receiving downlink data for a user device in response to sending the recovered data of the RF uplink signals to the destination device; and controlling transmission of an RF data downlink signal from the radio unit to the user device, the RF data downlink signal encoding the downlink data.

In some implementations, the at least one machine learning model includes a first machine learning model configured to perform channel estimation based on the samples of the RF uplink data signals; and a second machine learning model configured to perform symbol-demapping on estimated symbols of the RF uplink data signals. The estimated symbols are based on the channel estimation by the first machine learning model.

In some implementations, providing the samples of the RF uplink data signals as input to the at least one machine learning model includes providing the samples of the RF uplink data signals as input to the first machine learning model; obtaining, as an output of the first machine learning model, channel estimates characterizing channel effects on the RF uplink data signals; transforming the samples of the RF uplink data signals based on the channel estimates; providing the transformed samples of the RF uplink data signals as input to the second machine learning model; and obtaining, as an output of the second machine learning model, data indicative of the recovered data.

In some implementations, the channel estimates include a channel tensor.

In some implementations, the data indicative of the recovered data includes inferred bits.

In some implementations, the method includes training the first machine learning model and the second machine learning model in a joint training process. Training data in the joint training process includes RF resource grids, and labels for the training data include ground-truth inferred bits corresponding to the RF resource grids or ground-truth recovered data corresponding to the RF resource grids.

In some implementations, the at least one machine learning model is configured to receive inputs of varying sizes.

In some implementations, the at least one machine learning model includes a fully convolutional neural network.

In some implementations, the samples of the RF uplink data signals are provided as input in an orthogonal frequency division multiplexing (OFDM) resource grid form.

In some implementations, the samples of the RF uplink data signals include a subset of an uplink resource grid, the subset corresponding to an RF signal burst received from a user device.

In some implementations, the method includes executing the at least one machine learning model in an L1 layer of a distributed unit (DU).

In some implementations, the method includes training a first machine learning model of the at least one machine learning model. The training includes adjusting weights and parameters of the first machine learning model based on a loss function. The loss function is based on a comparison of (i) pilot values in uplink resource grids and (ii) ground truth values corresponding to the pilot values.

In some implementations, the method includes training a first machine learning model of the at least one machine learning model. The training includes adjusting weights and parameters of the first machine learning model based on a loss function. The loss function is based on a comparison of (i) data values in uplink resource grids and (ii) ground truth values corresponding to the data values.

In some implementations, the method includes simulating channel effects on the ground truth values, to obtain the data values as simulated pilot values.

In some implementations, the at least one machine learning model is configured to perform patch-based processing of the samples of the RF uplink data signals.

In some implementations, the at least one machine learning model has an architecture that includes at least one of a non-batch norm, or a Smooth ReLU activation function.

Some aspects of this disclosure describe another method. The method includes obtaining samples of radio-frequency (RF) uplink sounding signals received wirelessly at a radio unit of a radio access network, the RF uplink sounding signals including a first RF uplink sounding signal received from a first user device; providing the samples of the RF uplink sounding signals as input to at least one machine learning model; in response to providing the samples of the RF uplink sounding signals as input to the at least one machine learning model, obtaining, based on output of the at least one machine learning model, channel estimates characterizing effects of RF signal channels between user devices, including the first user device, and the radio unit; and controlling transmission of an RF downlink signal from the radio unit to the first user device based on the channel estimates.

This and other described methods can have one or more of at least the following characteristics.

In some implementations, the channel estimates include a channel tensor.

In some implementations, the channel tensor is a sparse tensor.

In some implementations, the at least one machine learning model is configured to determine the channel estimates based on a sparse regression across a resource grid representing the RF uplink sounding signals.

In some implementations, the at least one machine learning model is configured to determine one channel estimate for each resource block of the resource grid.

In some implementations, controlling transmission of the RF downlink signal from the radio unit to the first user device based on the channel estimates includes performing at least one of scheduling or beamforming based on the channel estimates.

In some implementations, the at least one machine learning model is configured to receive inputs of varying sizes.

In some implementations, the at least one machine learning model includes a fully convolutional neural network.

In some implementations, the samples of the RF uplink sounding signals are provided as input in an orthogonal frequency division multiplexing (OFDM) resource grid form.

In some implementations, the samples of the RF uplink sounding signals include a subset of an uplink resource grid, the subset corresponding to an RF signal burst received from the first user device.

In some implementations, the method includes executing the at least one machine learning model in an L1 layer of a distributed unit (DU).

In some implementations, the method includes training a first machine learning model of the at least one machine learning model. The training includes adjusting weights and parameters of the first machine learning model based on a loss function. The loss function is based on a comparison of (i) reference values in uplink resource grids and (ii) ground truth values corresponding to the reference values.

In some implementations, the method includes simulating channel effects on the ground truth values, to obtain the reference values as simulated reference values.

In some implementations, the at least one machine learning model is configured to perform patch-based processing of the samples of the RF uplink sounding signals.

In some implementations, the at least one machine learning model has an architecture that includes at least one of a non-batch norm, or a Smooth ReLU activation function.

Some aspects of this disclosure describe another method. The method includes obtaining (i) traffic queues for transmission of downlink data from a radio unit to a plurality of user devices and (ii) channel information characterizing RF signal channels between the plurality of user devices and the radio unit; providing (i) information corresponding to the traffic queues and (ii) the channel information as input to at least one machine learning model; and in response to providing the (i) information corresponding to the traffic queues and (ii) the channel information as input to the at least one machine learning model, obtaining, as an output of the at least one machine learning model, assignments of a multi-user schedule for the transmission of the downlink data to the plurality of user devices.

In some implementations of this method, providing the information corresponding to the traffic queues includes providing, as input to the at least one machine learning model, at least one of a priority, a service level, or an application type associated with each traffic queue.

In some implementations of this method, the method includes controlling transmission of the downlink data to the plurality of user devices using a multi-antenna radio unit.

Some aspects of this disclosure describe another method. The method includes obtaining (i) schedule information for data to be transmitted from a radio unit to a plurality of user devices and (ii) channel information characterizing RF signal channels between the plurality of user devices and the radio unit; providing (i) the schedule information and (ii) the channel information as input to at least one machine learning model; in response to providing (i) the schedule information and (ii) the channel information as input to the at least one machine learning model, obtaining, as an output of the at least one machine learning model, beamforming weights corresponding to a plurality of antennas of the radio unit; and controlling the plurality of antennas in accordance with the beamforming weights to transmit the data from the radio unit to the plurality of user devices.

Some aspects of this disclosure describe another method. The method includes training, by a module executing on a radio access network intelligent controller (RIC) of a radio access network (RAN), a neural receiver. The neural receiver includes one or more machine learning models configured to receive, as input, samples of radio-frequency (RF) uplink signals received at a radio unit of the RAN, and provide, as output, at least one of channel estimates or recovered data corresponding to the RF uplink signals. The method includes providing the neural receiver to an L1 component of the RAN; receiving, at the module executing on the RIC, a result of processing samples of RF uplink signals using the neural receiver executing on the L1 component; and retraining, by the module executing on the RIC, the neural receiver based on the result of processing.

This and other described methods can have one or more of at least the following characteristics.

In some implementations, the L1 component of the RAN includes a distributed unit (DU) of the RAN.

In some implementations, the module executing on the MC includes one of an xApp, a zApp, or an rApp.

In some implementations, providing the neural receiver to the L1 component includes providing the neural receiver to the L1 component using an E2 interface of the RAN.

In some implementations, retraining the neural receiver includes retraining the neural receiver using a loss function based on sparse estimates.

Some aspects of this disclosure describe another method. The method includes obtaining information about a state of a radio access network (RAN); based on the information about the state of the RAN, selecting a first machine learning model of at least two machine learning models configured to process RF signals received wirelessly at a radio unit of the radio access network, where the at least two machine learning models have different configurations; and, based on selecting the first machine learning model, processing the RF signals using the first machine learning model.

This and other described methods can have one or more of at least the following characteristics.

In some implementations, processing the RF signals includes performing at least one of channel estimation or data recovery using the RF signals.

In some implementations, selecting the first machine learning model is performed at a radio access network intelligent controller (RIC) of the radio access network, ands processing the RF signals is performed at a distributed unit (DU) of the radio access network.

In some implementations, the method includes, in response to selecting the first machine learning model, sending the first machine learning model from the RIC to the DU.

In some implementations, the at least two machine learning models further includes a second machine learning model that is larger in size than the first machine learning model. Selecting the first machine learning model includes in response to determining that the radio access network is under high network load, selecting the first machine learning model based on the first machine learning model being smaller in size than the second machine learning model.

In some implementations, the at least two machine learning models further includes a second machine learning model that is smaller in size than the first machine learning model, and selecting the first machine learning model includes, in response to determining that the radio access network is serving a low-density set of user devices, selecting the first machine learning model based on the first machine learning model being bigger than the second machine learning model.

In some implementations, the at least two machine learning models have at least one of different layer widths for one or more layers, different numbers of channels, different depths, or different numbers of inputs.

The foregoing and other methods and processes described herein can be implemented at least as methods, systems, devices, and non-transitory, computer-readable storage media.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a diagram illustrating an example of a network architecture.

FIG. 2 is a diagram illustrating an example of radio frequency (RF) signal processing.

FIG. 3 is a diagram illustrating an example of a data recovery process.

FIG. 4 is a diagram illustrating an example of a channel estimation process.

FIG. 5 is a diagram illustrating an example of a scheduling process.

FIG. 6 is a diagram illustrating an example of a beamforming weight determination process.

FIG. 7 is a diagram illustrating an example of a neural network training architecture.

FIG. 8 is a diagram illustrating an example of a neural network training process.

FIG. 9 is a diagram illustrating an example of a network architecture.

FIG. 10 is a diagram illustrating an example of a data recovery process.

FIG. 11 is a diagram illustrating an example of a channel estimation process.

FIG. 12 is a diagram illustrating an example of a scheduling process.

FIG. 13 is a diagram illustrating an example of a beamforming process.

FIG. 14 is a diagram illustrating an example of a training process.

FIG. 15 is a diagram illustrating an example of a model selection process.

FIG. 16 is a diagram illustrating an example of a computer system.

### DETAILED DESCRIPTION

This disclosure relates to the use of machine learning models in communication systems, such as radio access networks (RAN), to perform functions such as symbol equalization and uplink data recovery, channel estimation, scheduling, and beamforming. The described machine learning model deployments can be used, for example, in smart physical layer and virtualized RAN (vRAN) systems to improve key signal processing functions surrounding multiple-antenna system management. In the multiple-input multiple-output (MIMO) context, the machine learning model deployments can be applied to channel estimation in standard MIMO and Massive MIMO systems; for conveying and scheduling channel estimates for single and multi-user access; and for optimizing signal functions across a standardized vRAN deployment such as OpenRAN to improve user experience, link capacity, processing performance and/or power consumption, and/or to improve the overall function of multi-antenna radio access systems. In some implementations, the disclosed machine learning models are realized using neural networks. For example, as described herein, use of particular types of neural networks, neural networks trained in particular ways and/or having particular characteristics, neural networks executing in particular modules/layers of the RAN, and/or neural networks that interface in particular ways with other elements of the RAN, can provide improved RAN performance.

Multi-antenna systems, including Massive MIMO systems (e.g., having many antennas, such as 8, 16, or more) are widely deployed within 3GPP 5G radio access networks. Given the degrees of freedom associated with measuring and optimizing radio access in these and other systems (e.g., when deployed in cellular/spectral-reuse pattern configurations, multi-access-point deployment scenarios, and/or shared spectrum environments), existing algorithmic methods and software processing approaches often exhibit shortfalls. For example, channel estimation using physical uplink shared channel (PUSCH) tones or sounding reference signal (SRS) tones by applying a standard whitening filter, a noise estimation algorithm, and/or minimum mean square error (MMSE) or zero force (ZF) approaches to equalization, beamforming, etc., may fail to account for various factors that can influence signal formation and propagation, resulting in inaccurate estimation and lower spectral efficiencies. Some other approaches, such as maximum likelihood (MLD) and successive interference cancellation (SIC), have high computational complexity and may lead to increased processing latency, power consumption, and/or overall costs of base station operation.

As another example, some common scheduling algorithms are overly simplistic. These scheduling algorithms may focus on, for example, proportionally fair (PF) scheduling and decorrelation of users for scheduling, e.g., through heuristic means. These approaches do not account for many aspects of the real-world multi-antenna multi-user access optimization problem. Machine learning models, such as neural network-based processing, can leverage a data-driven and end-to-end approach for improved end-performance metrics, e.g., by accounting for more aspects of the system and for real-world responses of hardware and other effects in the processing loop.

As described herein, L1 and/or L2 processing functions of a RAN architecture can be performed using machine learning-based inference models, such as neural networks, thereby leveraging powerful non-linear approximations to perform processing, scheduling, estimation, and/or decision tasks. These machine learning-based inference models can also be optimized and improved (e.g., continuously and/or periodically) based on updates or changes in relevant probability distributions in environmental and hardware factors, and changes in user behavior and access distributions within the wireless environment. In the following sections, various novel architectures and techniques are described with reference to neural networks as one example of machine learning models. However, other types of machine learning models can also be used to realize the disclosed architectures and techniques.

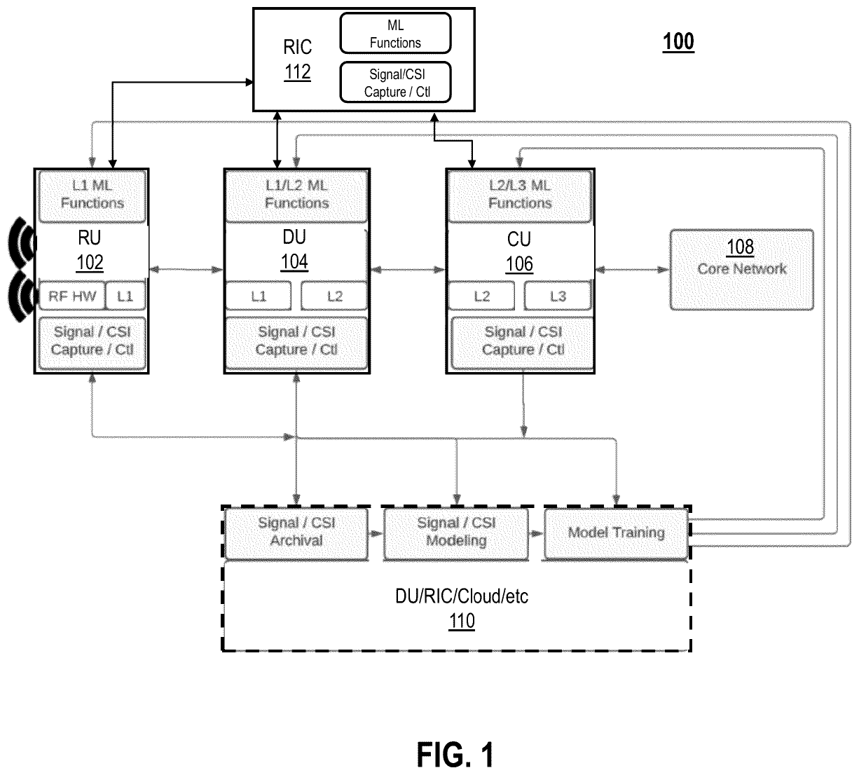

FIG. 1 illustrates an example of a RAN architecture 100 including neural network deployments. The RAN architecture 100 can be, for example, a 4G architecture, a 5G architecture, a 6G architecture, or another cellular architecture, in various implementations. More specifically, in some implementations, the RAN architecture 100 is a virtualized radio access network (vRAN) architecture or an open radio access network (O-RAN) architecture. In a vRAN architecture, network functions are virtualized to allow baseband functions to run on off-the-shelf hardware, such as software servers. For example, network functions can be virtualized in the cloud. O-RAN is an extension of vRAN in which network functions and interfaces are non-proprietary, virtualizable, and interoperable between different suppliers, with a set of unified standards (e.g., pre-defined functions) used to obtain information from and control the O-RAN architecture.

The RAN architecture 100 includes a radio unit (RU) 102, a RAN Intelligent Controller (MC) 112 that can, in some implementations, host one or more xAPPs, rAPPs, and/or zAPPs, a distributed unit (DU) 104, a central unit (CU) 106, and a core network 108. The RU 102 is a field-deployed hardware unit including RF hardware configured to receive and/or transmit wireless RF signals (e.g., transceiver(s) and/or antenna(s)), an analog-to-digital converter configured to convert received analog RF signals into a digital form, a computing system configured to perform signal analysis and/or processing, etc.). In some implementations, the RU 102 includes multiple antennas for MIMO processing.

The DU 104 is a base station unit, e.g., forming a portion of a 5G-gNB. The DU 104 provides support for lower layers of the RAN protocol stack such as radio link control (RLC), medium access control (MAC) and physical layer. The DU 104 can include discrete hardware (e.g., as a base station device located physically near the RU 102) and/or can be wholly or partially virtualized. The DU 104 works in conjunction with the CU 106, which forms another portion of the base station unit. The CU 106 may be integrated, for example, into a cloud service and/or other computing system(s). The CU 106 provides support for higher layers of the RAN protocol stack such as service data adaption protocol (SDAP), packet data convergence protocol (PDCP) and radio resource control (RRC), and interfaces with core network elements, such as the 5G Core. The CU 106 can be located further from the RU 102 than the DU 104, e.g., as a back-end or mid-level hardware and/or software component, and can be wholly or partially virtualized.

The RIC 112 is a services layer that sits over the DU 104 and the CU 106 to perform control, optimization, and tuning of RAN functions. The MC 112 can be divided into a non-real-time MC and a near-real-time MC. In some implementation, the non-real-time-RIC provides greater than one-second latency control of RAN elements and their resources, while the near-real-time RIC regulates actions that take between 10 milliseconds to one second to complete; these latency requirements can vary depending on the target timeline for sensing and recognition and reaction in the process flow 200. In some implementations, the non-real-time MC exchanges data with the near-real-time RIC (e.g., over an A1 interface), and the near-real-time RIC exchanges data with the DU 104 and the CU 106, e.g., over an E2 interface. The RIC 112 can be wholly and/or partially virtualized, e.g., as a hardware and/or software module. Some implementations of the RIC 112 can include a real-time RIC for real-time operations.

Operations of the RIC 112 can be performed using xAPPs, which reside in/execute on the near-real-time RIC. xAPPs are software tools/plugins, e.g., which can be cloud-native microservice-based applications. xAPPs operate using a public protocol, such that xAPPs can be developed by third-parties for use in the RAN architecture 100. In an example of an interaction between the RIC 112 elements and the DU 104/CU 106, the non-real-time RIC provides network metrics to the near-real-time RIC over an A1 interface. An xAPP executing in the near-real-time RIC obtains the network metrics and processes the network metrics to determine one or more control parameters for edge control of RAN elements, e.g., control of the DU 104 and/or the RU 102. The xAPP sends commands to the DU 104 over an E2 interface to actualize the control parameters. rAPPs and zApps, analogous to xAPPs, reside in/execute on the non-real-time RIC or in a real-time RIC respectively.

The RAN architecture 100 can be functionally divided into L1, L2, and L3 layers. L1, sometimes referred to as the “real-time” or “physical” layer, involves radio frequency (RF) reception and transmission, e.g., between user devices (e.g., 3GPP user equipment (UE) and the RU 102, along with low-level signal processing such as modulation, encoding, or filtering, among others. L2, sometimes referred to as the “data link” layer, involves management of signal reception/transmission and data transfer between elements of the RAN architecture 100, including, for example, multiplexing and de-multiplexing of data on various logical channels and resource scheduling for uplink/downlink transmission. L3, sometimes referred to as the “network” layer, involves higher-level aspects of call setup, data routing, and core integration.

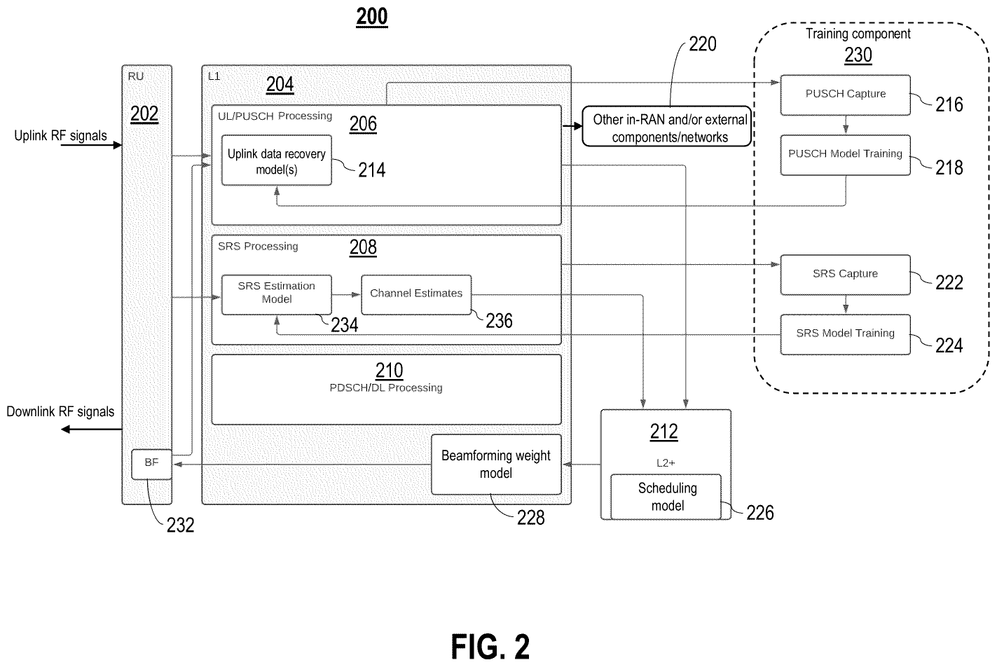

A computing system of the RU 102 can be configured to perform L1 functions; a computing system of the DU 104 can be configured to perform L1 and/or L2 functions; and a computing system of the CU 106 can be configured to perform L2 and/or L3 functions. Combinations of two or more of these and/or other computing systems can be referred to collectively as a computing system. For example, “a computing system” can refer to both RU 102 and DU 104 computing systems. A computing system can include one or more processors (e.g., in RU hardware, DU hardware, and/or RIC hardware) and one or more memory devices (e.g., in RU hardware, DU hardware, and/or MC hardware) storing instructions that are executed by the one or more processes to perform various operations, such as the processes illustrated in FIGS. 2-15.

A core network 108, such as a 5G Core (5GC), interfaces with other elements of the RAN architecture 100 to perform back-end functions, route data to other networks/devices, perform control plane operations, among others.

As shown in FIG. 1, one or more of the RU 102, DU 104, CU 106, and/or MC 112 can implement machine learning (ML) functions using one or more neural networks. For example, one or more of the RU 102, DU 104, CU 106, and/or RIC 112 can obtain RF signals and/or channel state information (CSI) and used the obtained information as inputs to the neural networks to control RAN functions.

As further shown in FIG. 1, a training component 110 (which may include and/or be integrated into, for example, the DU 104, the CU 106, the MC 112, and/or a cloud computing system communicatively coupled to the RAN architecture 100) is configured to train and/or retrain one or more machine learning models (e.g., one or more neural networks) of the RAN architecture 100. For example, the training component 110 can be configured to obtain signal and/or CSI data (e.g., from over the air signal capture or from an archive), perform modeling based on the signal and/or CSI data, and perform neural network training and/or retraining (operations collectively indicated as “Ctl” in FIG. 1). The trained and/or retrained neural networks can then be provided to the RU 102, DU 104, CU 106, and/or MC 112 for use.

In the RAN architecture 100, signal and CSI capture by the DU 104, CU 106, and/or RU 102 can be mediated by E2 interface software and/or hardware (“E2 agents”) which run alongside software of the DU 104, CU 106, and/or RU 102. E2 agents can, for example, run on the DU 104, CU 106, and/or RU 102 and provide interfaces between these components and the RIC 112. An E2 agent can, for example, provide/include one or more application programming interfaces (APIs) configured to handle MC messages.

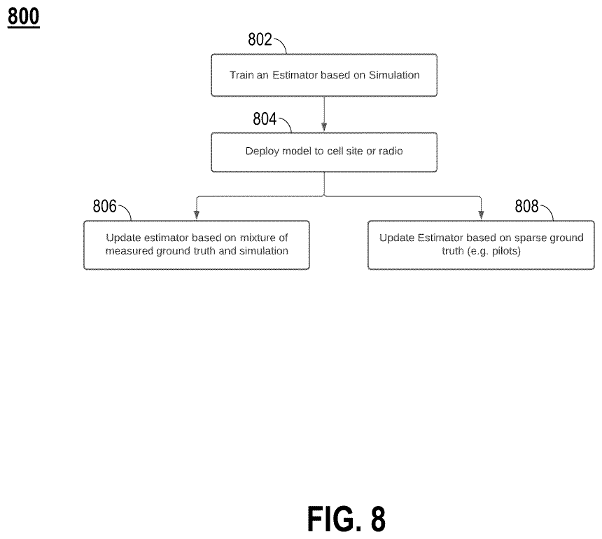

In the context of the processes discussed herein, E2 agents provide access to captured signals and associated information, such as PUSCH resource grids, SRS resource grids, received sample data, received spatial information about users in a cell of the RAN, information about uplink and/or downlink data transmissions, sizes, rates, and types, and/or other data and metadata flowing generally through uplink and downlink paths of the RAN architecture 100. E2 agents can be configured to provide this information over an E2 link, using a RIC message router (RMR) protocol or a similar protocol. For example, the information can be provided to a signal archival and/or training module which may typically be deployed and operate as an xAPP inside the RIC 112, e.g., as described in reference to FIG. 9.

FIG. 2 illustrates an example of a process flow 200 for reception and transmission of RF data. Some or all of the illustrated processes can be performed, for example, using the RAN architecture 100 of FIG. 1, such that elements of FIG. 2 can have characteristics as described for corresponding elements of FIG. 1. The process flow 200 represents an overview of RF signal processing; details on various elements of the process flow 200 are discussed with respect to subsequent drawings.

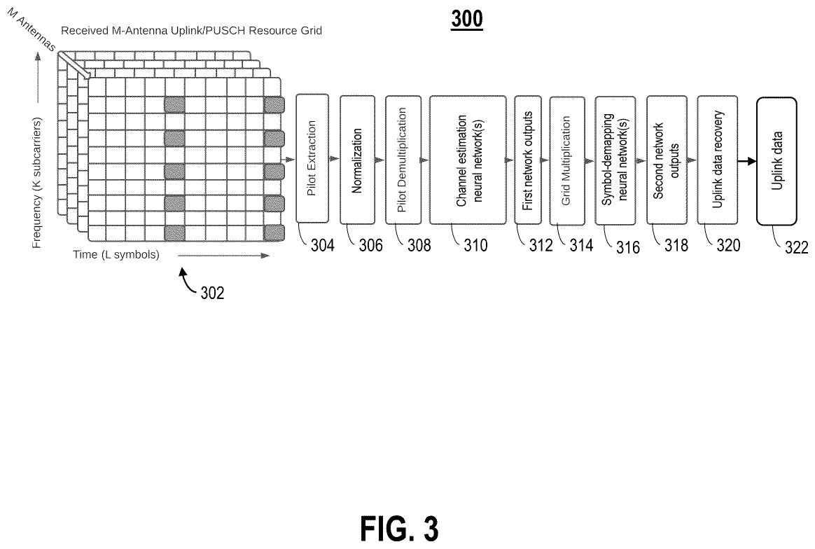

As shown in FIG. 2, an RU 202 (e.g., similar to RU 102) receives uplink RF signals, e.g., from multiple user devices. The uplink RF signals can include symbols (encoded data) and/or sounding reference signals (SRS) to be used for channel estimation. In an L1 layer 204, an uplink(UL)/PUSCH processing component 206 obtains a representation of the uplink RF signals, e.g., in a PUSCH resource grid format such as an orthogonal frequency-division multiplexing (OFDM) grid format as described in reference to FIG. 3). The L1 processing functions can be performed, for example, by the DU 104.

In real-time and/or non-real-time, PUSCH data is captured (216) by a training component 230 (e.g., training component 110 as described in reference to FIG. 1, such as an application executing on a RIC). The PUSCH data can include, for example, past PUSCH data for which corresponding performance metrics are available. The training component 230 is configured to train (218) one or more neural networks configured to perform one or more tasks for uplink data recovery. The training process can be performed, for example, as described in reference to FIG. 3.

Using the trained one or more neural networks as uplink data recovery models 214, the UL/PUSCH processing component 206 performs uplink data recovery to obtain original data sent by user devices. The uplink data recovery can include, for example, channel estimation, symbol equalization and estimation, bit-to-codeword demapping, and error correction, to recover as-transmitted uplink RF data from the perturbed uplink RF signals received at the RU 202. Uplink data recovery can be performed, for example, as described in reference to FIG. 3, in which the uplink data recovery models include neural networks 310, 316.

The recovered uplink data can be passed to other components of the RAN and/or one or more other networks 220, for example, to determine downlink data to send to user devices from the RU 202. In some implementations, the recovered uplink data is sent to a destination outside the RAN, e.g., a destination device, which can be a network device or a user device. This can include, for example, passing the uplink data through a user plane function (UPF), through the Internet, and to a target destination, which can return downlink data as a response to the uplink data. For example, the uplink data can include a request for content, and the downlink data can include the content. The RU 202 can then operate/be controlled to transmit the downlink data to user devices as downlink RF signals, e.g., using multiple antennas according to a determined downlink transmission schedule and associated beamforming weights. In some implementations, the destination device is within the RAN, e.g., the recovered data can be (though need not be) sent within the RAN.

In addition, in some implementations, other outputs of the UL/PUSCH processing component 206 (such as channel estimates (e.g., H), quality metrics such as channel quality indicator (CQI), signal-to-noise ratio (SNR), and/or carrier-to-interference ratio (CIR), etc.) are provided to the L2 and/or L2+ layer 212 for use in scheduling.

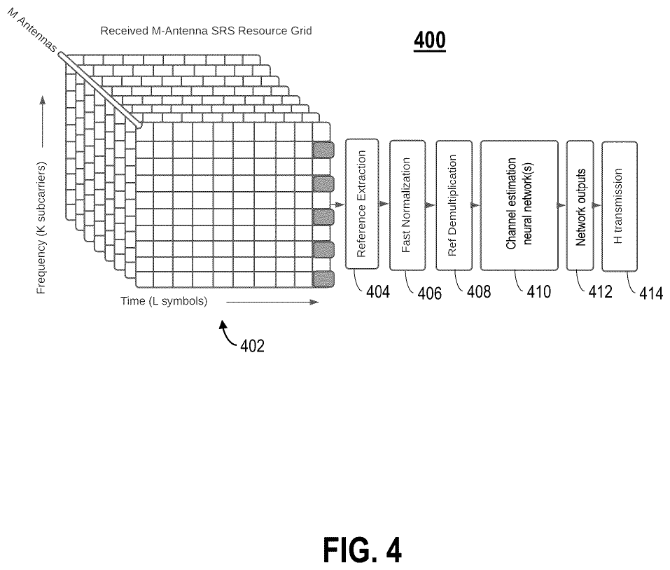

An SRS processing component 208 obtains a representation of uplink SRS signals (e.g., in an SRS resource grid form as described in reference to FIG. 4). One or more neural networks for SRS estimation are trained by the training component 230, which is configured to capture SRS data (222) and perform training (224) based on the captured SRS data, e.g., based on past SRS data labeled with corresponding performance metrics. The trained one or more neural networks perform SRS-based channel estimation as an SRS estimation model 234 to obtain channel estimates 236 which characterize respect channels between the RU 202 and one or more user devices that transmitted the uplink RF signals to the RU 202. Further details on SRS estimation using neural networks are provided in reference to FIG. 4.

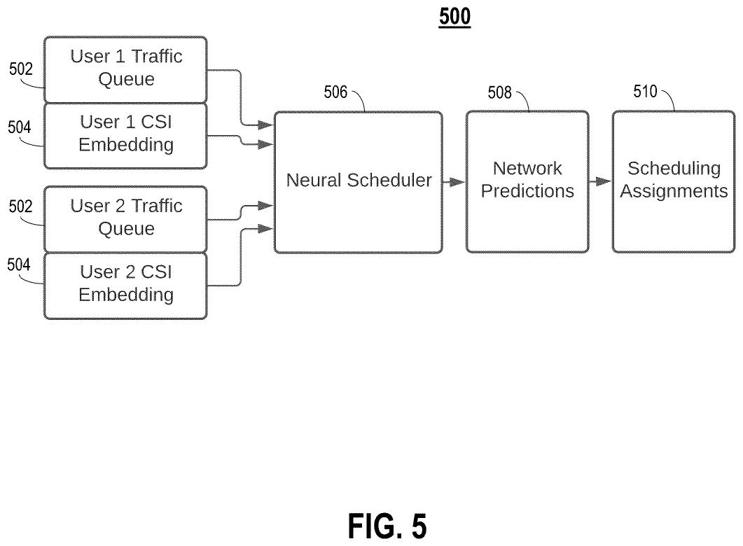

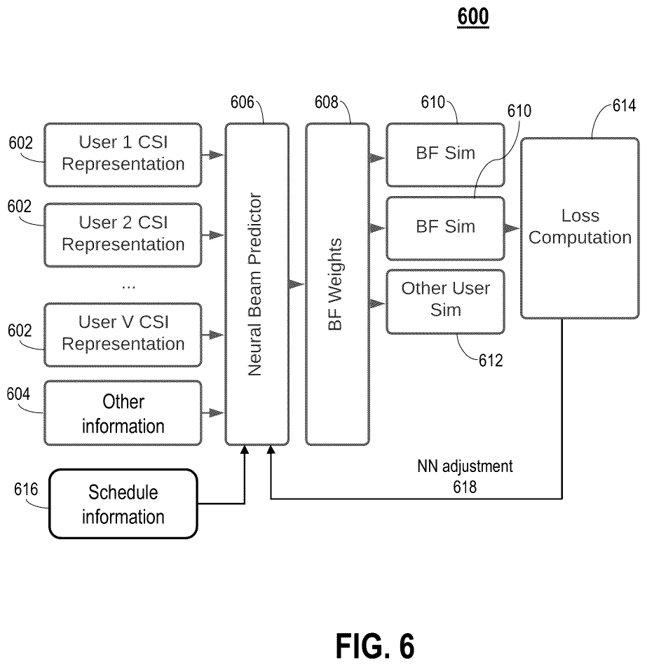

An L2 and/or L2+ layer (e.g., an L2 and/or L3 layer) 212 implements one or more neural networks as a scheduling model 226 to determine scheduling for downlink RF signal transmission of data including the determined downlink data. Scheduling can be performed at least partially based on the channel estimates 236. The L1 layer 204 implements one or more neural networks as a beamforming weight model 228 to determine, based on the determined scheduling, channel estimates 236, and/or other data, beamforming weights for transmission of downlink RF signal transmission by multiple antennas of the RU 202, e.g., to multiple user devices. A beamforming component 232 of the RU 202, such as an antenna array, uses the beamforming weights to perform the transmission of the downlink RF signals. Further details on scheduling using one or more neural networks are provided in reference to FIG. 5, and further details on beamforming using one or more neural networks are provided in reference to FIG. 6. L2/L2+ functions can be performed, for example, by the DU 104.

Although not shown in FIG. 2, the one or more neural networks of the scheduling model 226 and/or the beamforming weight model 228 can be trained by the training component 230 and/or by another training component, e.g., as described in reference to FIGS. 5-8. Moreover, although FIG. 2 illustrates the L1 layer 204 and L2+ layer 212 as separate from the RU 202, in some implementations the RU 202 executes at least some L1 and/or L2 functions. For example, one or more of the processes 300, 400, 500, and 600 can be executed on the RU 202 (and/or on the DU or elsewhere, as discussed below). Performing one or more of these processes using the RU can improve processing and channel adaptation latency while reducing requirements on front-haul bandwidth and latency.

Accordingly, as shown in FIG. 2, neural networks can be used in a RAN architecture for one or more of at least four tasks: uplink data recovery (which, as noted above, can include a channel estimation portion), channel estimation, scheduling, and beamforming weight determination. As discussed throughout this disclosure, particular types/formats of the neural networks, methods of training the neural networks, aspects of executing the neural networks, and transferring inputs/outputs of the neural networks can result in improved signal reception and/or transmission results. Moreover, the use of neural networks itself can be advantageous for improving performance metrics compared to methods that do not utilize neural networks for these and/or other tasks.

In the process flow 200, functions of the L1 layer 204 can be performed, for example, by the DU, e.g., DU 104. Functions of the L2+ layer 212 can be performed, for example, by the DU and/or CU, e.g., DU 104 and/or CU 106. The training component 230 can be, for example, one or more applications executing on a MC, e.g., RIC 112. However, other and/or additional modules may perform one or more of these functions. Moreover, elements of the process flow 200 may be implemented as hardware modules and/or software modules.

FIG. 3 illustrates an example of a process 300 of uplink data recovery, including processing by one or more neural networks. The process 300, or a portion thereof, can be performed, for example, by the UL/PUSCH processing component 206, e.g., by the one or more uplink data recovery models 214, which can include the neural networks described in reference to FIG. 3 below. For example, the process 300 can be performed by DU 104.

Uplink data recovery is performed based on received RF signals. For example, samples of received RF signals may have the form of a resource grid. In the example of FIG. 3, the samples are in the form of a PUSCH resource grid 302. The PUSCH resource grid 302 can be, for example, an unequalized OFDM resource grid having one or more two-dimensional time-frequency grids with L-symbols in time (e.g. a half slot, a full slot, or another number of symbols) and K-frequency subcarriers. In this case of a multi-antenna RU, a third dimension is formed with one two-dimensional grid for each antenna, resulting in the PUSCH resource grid 302 having the form of a tensor. The tensor can be a real- or complex-valued tensor. For example, a real-valued tensor can be obtained by flattening complex values into the antenna dimension (M) in rectangular or polar form, e.g., interleaved, and/or by introducing complex values as a fourth dimension of the tensor.

The grid can be, for example, a full receive grid, e.g., capturing all symbols in time and all symbols in frequency corresponding to one slot of time in a PUSCH uplink received at the DU from an RU having a MIMO antenna array (e.g. where the L, K, and M values can be associated with a full base station maximum allocation in which K corresponds to a full link bandwidth (e.g., 20 MHz for a 20 MHz uplink bandwidth part), all time symbols within a slot are represented (e.g., 12 or 14), and all receive antennas are represented by M). In some implementations, a subset of a grid is captured and processed. For example, in some implementations, the grid reflects a specific user allocation which includes (e.g., is limited to) a subset of all available L, K, and M values, such as a partial spectral allocation (e.g. subset of L and K and, in some implementations, M) that corresponds to a single transmission from a user or a single set of received layers in the same time-frequency chunk.

The grid can be obtained over an appropriate interface of the RAN, such as an OpenRAN 7.2 split open-front haul interface between the RU and the DU, and/or the grid can be obtained within DU or RU processing. For example, in some implementations a process runs on an intermediate buffer within the DU which includes grid data, and the grid is obtained from the buffer. As another example, in some implementations (e.g., in OpenRAN 7.2c architectures) SRS and/or other reference signal tones can be extracted at the RU itself for processing.

In some implementations, one or more pre-processing operations 304, 306, 308 are performed on the grid representing RF signal samples. In the neural network context, these and/or other pre-processing steps may be useful, because the pre-processing's computational complexity may be sufficiently low to reduce the computational burden (e.g., neural network size) compared to performing neural network processing without pre-processing.

In a pilot extraction process (304), pilot symbols (sometimes referred to as reference symbols) in the grid are isolated, e.g., their corresponding indices are determined. These isolated, predetermined pilot symbols (e.g., a sparse set of pilots in the grid 302) can subsequently be used for channel estimation. The pilot symbols can correspond, for example, to a demodulation reference signal (DMRS) included in the received RF signals. In a normalization process (306), power values corresponding to elements of the grid are normalized. For example, peak power bit-shifts can be normalized to within a predetermined power range (e.g., 1 to 3 dB) of a nominal/standard power level. In the neural network context, normalization can be advantageous by allowing one or more subsequent neural networks to be configured (e.g., by training) to process power levels within a nominal power variation range determined by the normalization, e.g., as opposed to a wider power range corresponding to un-normalized grid elements. The normalization process (306) can include, for example, a fast normalization process and/or an approximate normalization process. Normalization can be performed for one or more groupings of data, for example, on a per-antenna basis, on a per-subcarrier basis, and/or on an overall basis.

In a pilot demultiplication process (308), the isolated pilot symbols are analyzed in reference to ground-truth values such as DMRS values, e.g., by performing complex conjugate multiplication, division, de-rotation, and/or an equivalent process. This represents the removal of some channel effects, e.g., the application of inverse channel effects to pilot symbols in the grid 302. For example, in a whitening process, pilot elements of the grid 302 can be filtered/phase-shifted to obtain a representation of the pilot elements in which channel effects have been reduced, e.g., by transforming the phases to a known mean value.

After pre-processing (if present), one or more channel estimation neural networks 310 are used to determine first network outputs 312 that represent at least channel effects. For example, while sparse pilot elements of the grid 302 may provide a sparse channel estimate for a subset of elements of the grid 302, the first network outputs 312 can include a dense, interpolated grid including a prediction of a complex channel parameter for each element of the grid 302. For example, the first network outputs 312 can include channel state information (CSI), e.g., an estimate for a channel matrix/tensor H that represents the channel response across DX resource elements and N×M receive layers by receive antennas (where Nis the number of layers), and/or an estimate of the inverse of H. In some implementations, the first network outputs 312 include an estimate for the noise variance and/or standard deviation values for one or more elements of H (e.g. sigma values), providing an indication of the noise associated with elements of the channel estimates and, accordingly, the noise associated with elements of the grid 302. The CSI can describe how a signal propagates from the transmitter of a user device to the receiver of the RU, representing, for example, the effects of one or more of scattering, fading, or power decay with distance. For example, an H can be estimated for each user device providing signals characterized by the resource grid 302.

The inputs to the one or more channel estimation neural networks 310 can include, for example, all or subsets of the received RF signal samples (in some implementations having been pre-processed in one or more ways, e.g., normalized and/or transformed such as described for elements 304, 306, 308). For example, in some implementations, the received RF signal samples include an entire RF signal representation, e.g., all L, K, and M of a multi-antenna resource grid. In some implementations, the received RF signals samples include one or more burst allocations of various sizes, e.g., a subset across L, K, and/or M of the grid 302. For example, the input can be a sample of one user burst within a PUSCH uplink data allocation. In some implementations, the partial resource grid (subset across L, K, and/or M) is a continuous portion of the resource grid, e.g., continuous in each of L, K, and/or M. Moreover, when a full or partial resource grid is provided as input, the input can be all elements of the full or partial resource grid (e.g., both pilot/reference and data elements), or pilot/reference elements only. The former process may, in some cases, provided better channel estimation accuracy than the latter process, while potentially incurring higher computational cost. In some implementations, the input is all pilot/reference elements of the full or partial resource grid, and a sparse selection of the data elements of the full or partial resource grid. This “hybrid” approach can provide the more-accurate channel estimates associated with pilot+data-aided estimation while incurring reduced computational cost compared to including all elements in the input.

The one or more channel estimation neural networks 310 can include one or more types of neural network, such as a convolutional neural network, an artificial neural network, a recurrent neural network, and/or a residual neural network. In some implementations, the one or more channel estimation neural networks 310 are configured to receive inputs of varying sizes, e.g., are fully-convolutional neural networks. The use of neural networks configured in this way can be particularly advantageous for the purposes discussed herein, e.g., in which grids representing samples of received RF signals are used as input. In some implementations, the grids provided as input may not have a constant size, and/or varying-size subsets of the grids can be used. For example, the L and/or K dimensions that are provided as inputs to the one or more channel estimation neural networks 310 can be scaled based on, for example, a burst size. Fully-convolutional neural networks can be configured to properly handle these scaling-size inputs. For example, in the case of a base station having a given bandwidth (e.g., 100 MHz), the bandwidth corresponds to a particular data size, e.g., (273 resource blocks×12) subcarriers forming a total K that can be allocated. In the case of receiving a packet from a user device that has a certain size (e.g., 20 bytes), all the subcarriers may not be used. Accordingly, a scheduler may assign to the user device a burst corresponding to a subset of subcarriers, e.g., subcarriers 0 to 100, with another user device allocated subcarriers 101 to 300. The different allocated bursts therefore correspond to different rectangular regions of the resource grid 302 that are allocated to different user devices, where the regions can have different sizes based on scheduling. Neural networks (e.g., channel estimation neural networks 310) that are capable of receiving varying-size inputs, such as fully-convolutional neural networks, can receive, as inputs, these varying-size portions of resource grids, without requiring neural network re-training or use of separate neural networks for different sizes of input data. Accordingly, computational efficiency and/or storage space can be increased compared to solutions that require retraining and/or different neural networks for different-sized inputs.

In some implementations, the one or more channel estimation neural networks 310 have an architecture that incorporates patch-based processing, such as a convolutional mixer (convmixer) architecture or similar architecture. For purposes of this disclosure, it has been recognized that the patch-based (e.g., convmixer) approach may be particularly-well suited for purposes of RF signal analysis (e.g., channel estimation and/or data recovery), for example, because resource grids have a tensor form associated with convmixer patch embeddings, and/or because the physical effects underlying channel estimation are amenable to patch-based processing, e.g., due to physical effects that are continuous in frequency. In a convmixer architecture, patches are extracted from the grid input (e.g., a full-grid or partial-grid input), such that embeddings can be learned for local regions of the grid (e.g., for patch regions of the grid which might be small (such as 7 (symbols)×7 (subcarriers)) or other-sized regions (such as 512×14)). In some implementations, the neural networks are configured to perform the patch-based processing on patches that fit into resource block boundaries. For example, a 14 (symbols)×12 (subcarriers) resource block can be divided into 7×3 patches to fit on integer boundaries. As another example, a 2 (pilot symbols)×7 (pilot subcarriers) resource block (e.g., sparsely extracted) can be processed using a 1×7 or 2×7 patch size. In some implementations, a patch can include multiple resource blocks. One or more parameters such as depth, width of each layer, parameters of the activation functions, etc., can be selected to trade off accuracy and complexity/latency in this network.

By processing on patches, local relationships can be learned and remapped, in some cases with lower parameter count and lower computational complexity in order to attain, in some cases, the same or better accuracy as a traditional convolutional or residual convolution based approach. In some implementations, latency can be decreased significantly compared to approaches that do not incorporate patch extraction. Convmixer-type architectures are described generally, without reference to radio signal analysis or resource blocks, in “Patches Are All You Need?” Trockman et al. (2022).

In some implementations, the neural networks (e.g., networks 310, 410, and/or 416) have architectures specifically adapted for uplink/downlink RF data processing. For example, in some implementations, a non-batch norm such as group norm, layer norm, sample norm, or frozen batch-norm is used, which can provide more stable input under conditions of changing batch size and/or varying input grid dimensions (e.g., L and/or K dimensions). As another example, in some implementations, the neural networks omit at least some normalization layers and/or global average pooling (GAP) functions, improving efficiency and reducing processing latency. As a further example, in some implementations, a Smooth ReLU (SmELU) activation function is used, providing reduced latency with little or nor loss in performance compared to other activation functions, such as the traditional GELU activation function.

In some implementations, a neural network architecture based on a sequence of consecutive multi-layer perceptron (MLP) blocks is used. In some implementations, the architecture is a hierarchical MLP architecture, e.g., such as ConvMLP.

Training of the neural networks 310 and/or 316 can be performed separately or jointly. In an example of a joint training process, the neural networks 310 and 316 are trained using training data such as one or more uplink data resource grids, or portions of resource grids. The resource grids include pilot values and/or data values. The labels of the training data can be as-transmitted (true) pilot values and/or data values, e.g., “perfectly-transmitted” pilot and/or data values. The true pilot values are known based on frame parameters, and, for example, the neural networks 310 and 316 can be trained to minimize error in predicted pilot values, e.g., based on a sparse loss function. In some implementations, pilot-based training is sufficient to obtain neural networks and 316 that can predict data values in addition to pilot values. Alternatively, or in addition, a demodulated PUSCH burst that passes a checksum check (e.g., after bit correction) can be re-modulated to obtain a ground truth for the data values, such that the neural networks 310 and 316 can be trained based on a loss function between predicted data values and the ground truth data values. For example, in an example of a joint training process, the training data can include raw resource grids having the form of grid 302 and/or pre-processed resource grids processed according to one or more of elements 304, 306, or 308, and the training data can be labeled with ground-truth second network outputs 318 or uplink data 322, such that the joint training process incorporates channel estimation (310), grid multiplication (314), symbol-demapping (316) and, in some implementations, uplink data recovery (320). In some implementations, the training includes back-propagation, e.g., based on differentiable intermediate steps (such as 312, 314).

In some implementations, instead of or in addition to joint training, the networks 310 and/or 316 can be trained separately. For example, to train the channel estimation neural networks 310 separately, the training data can include one or more uplink data resource grids, or portions of resource grids, that include pilot values and/or data values, and the labels of the training data can include ground-truth channel estimates or results of the channel estimates, such as H and/or as-transmitted resource grid elements (e.g., obtained by simulation or otherwise). To train the symbol-demapping neural networks 316, the training data can include bits (e.g., soft log-likelihood bits), and the labels of the training data can include ground-truth inferred bits.

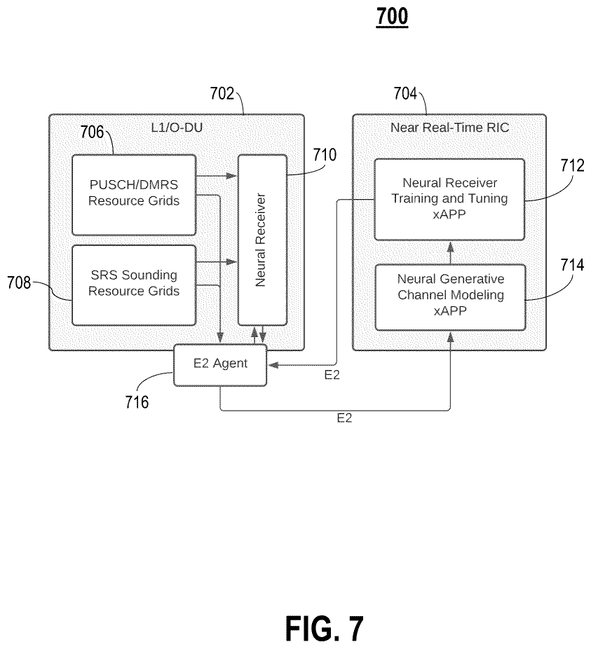

Any of the foregoing training processes can be simulation-based as described in reference to FIG. 7.

Accordingly, the neural networks 310 and/or 316 can be trained to predict as-transmitted data based on as-received data that has been altered by channel effects. As a result of the training, the neural networks 310 and/or 316 include a set of weights and parameters that configure the neural networks to perform channel estimation and/or symbol-demapping, e.g., when deployed in the L2 layer (such as in the DU).

The outputs 312 of the one or more channel estimation neural networks 310 are used to recover estimated symbols of the grid 302. For example, the outputs 312 can regress symbol values, receive values, and/or estimated transmit values. For example, in some implementations, the outputs 312 include and/or represent H and/or sigma values associated with channel effects. In an example of a grid multiplication process 314, the inverse of H, H⁻¹, is multiplied by the received resource grid 302 to obtain an estimated set of received symbol values. As another example of the grid multiplication process 314, an MMSE receiver approach may be used to compute an estimated set of received symbols by combining an H estimate with a sigma estimate (e.g., using a similar equation to a traditional MMSE receiver equation, and/or another equation which analogously scales and combines H and sigma).

In some implementations, the channel estimation neural networks 310 are trained to perform some or all of the grid multiplication process 314. For example, the channel estimation neural networks 310 can be trained to output a combination of H and sigma, such as the MMSE equalization matrix W; this configuration can, in some implementations, reduce the computational resources consumed compared to non-ML processes.

The estimated symbols (e.g., as output by the grid multiplication process 314) can be demapped into bits (e.g., soft log-likelihood bits) of the data transmitted in the received RF signals represented by the grid 302. In some implementations, the demapping is performed algorithmically using the estimated symbols, e.g., using a hard-slicer or a soft-demapper such as a log-likelihood approximation or full log-map log-likelihood ratio (LLR) calculation. In some implementations, symbol demapping is performed using one or more symbol-demapping neural networks 316. The symbol-demapping neural networks 316 are configured to receive, as input, estimated symbols (e.g., in a grid form) and to output bit values corresponding to the estimated symbols. For example, the symbol-demapping neural networks 316 can be trained to approximate LLRs by behaving as an approximate symbol-to-LLR demapping inference function which provides a non-linear and computationally efficient mapping. The second network outputs 318 can include the inferred bits (e.g., in a likelihood form as soft-bits) resulting from the demapping process.

In some implementations, the symbol-demapping neural networks 316 have characteristics as described for the channel estimation neural networks 310. For example, the symbol-demapping neural networks 316 can be fully-convolutional neural networks to obtain the above-discussed advantages with respect to scalable inputs. For example, the symbol-demapping neural networks 316 can be configured to receive inputs having a scalable number of symbols. In some implementations, the symbol-demapping neural networks 316 include different models (e.g., separate networks or separate subsets of a common network) for handling symbols with different numbers of bits. For example, the symbol-demapping neural networks 316 can include a first neural network or subset of a network configured to receive, as input, estimated symbols having a first number of bits per symbol, and a second neural network or subset of a network configured to receive, as input, estimated symbols having a second, different number of bits per symbol.

The use of the channel estimation neural network 310 and/or the symbol-demapping neural networks 316 can provide advantages for RF signal operations. For these networks 310 and/or 316, in some cases, a trade-off exists between accuracy and computational complexity (e.g., corresponding to network size). In some implementations, the networks 310 and/or 316 can have sizes that are configured based on the accuracy requirements of the networks 310 and/or 316. For example, for applications/circumstances where high link margin and/or spectral efficiency are desired, larger networks can be used for the networks 310 and/or 316, while smaller networks 310 and/or 316 can be used for applications/circumstances where low-latency, high-speed, and/or low-power are desired. For example, larger networks can have wider layers, more channels, and/or more depth than smaller networks. In some implementations, larger networks are configured to receive a larger number of inputs than smaller networks.

In an example of a model selection process, a first, larger network provides better spectral efficiency than a second, smaller network, which itself provides better latency than the first network. A selection module, such as the UL/PUSCH processing component 206 or a RIC application, is configured to select between the first and the second model based on a context of the RAN, e.g., current demand in the sector. For example, if the UL/PUSCH processing component 206 is included in a base station that serves a wide geographic area, a priority might be increasing link margin, such that the first network would be selected. By contrast, a base station that serves a small area may optimize for latency by selecting the second network. In some implementations, the selection is dynamic, e.g., based on real-time or near-real-time conditions, e.g., current resource demands. For example, if RAN demands are such that computational capacity, network capacity, and/or power resources are being stressed, the second network can be selected, e.g., to reduce power consumption.

In some implementations, different neural networks (e.g., different versions of networks 310 and/or 316) can be trained for different conditions, e.g., time-of-day, load conditions, whether one or more events are occurring, etc. In some implementations, model selection can be performed by an elements besides the UL/PUSCH processing component 206. For example, in some implementations a management component (such as an application executing on a RIC, where the application can be, for example, the same as or associated with the training component 230) performs model selection and provides the selected model and/or a command to use the selected model to the UL/PUSCH component 206.

This adaptability may not be provided by some other approaches, such as receivers that implement traditional MMSE algorithms which have a single operating point with a single corresponding computational complexity and a single corresponding spectral efficiency. By contrast, receivers that implement neural networks such as the networks 310 and/or 316 can operate at various points on a computational complexity-spectral efficiency curve. The approaches described herein can provide an almost continuous trade-space between neural network low-latency and neural network accuracy, with the convenience and interoperability of common methodology, software, APIs, interfaces and protocols, and training and monitoring methods. Accordingly, wireless access points can be tuned to operate at different ends of the spectrum depending on network and operator demands and objectives. For example, during low-load times or for lowly-populated rural cells, systems can be operated in a way which maximizes model accuracy and resulting link-margin and coverage within the wireless access point, e.g., by selection of a large, highly-accurate neural network. Similarly, within dense urban cells and within peak-load times, and/or when running up against computational limits or capacity in computing infrastructure (or virtualized server load), neural networks may be selected for reduced complexity and slightly reduced accuracy and link-margin in order to optimize instead for user-load and compute or multi-cell capacity instead of coverage or sensitivity. This trade-off can be dialed virtually to any operating point along the frontier of trainable neural networks between these multiple objectives. This is a useful advantage of the systems and processes described herein, in that operators can define high level end-to-end system objectives such as computer load, cell coverage, etc., which can then guide RU and DU processing at the edge, including within the L1 where these decisions would previously been made, for example, by a digital signal processing engineer in a lab at design time without prior insight into the specific deployment optimization scenario.

Based on the output bit values (obtained by algorithmic and/or neural network-based processing), uplink data recovery 320 is performed. The uplink data recovery 320 can include, for example, rate dematching, codeword mapping, decoding (e.g., channel decoding), and error correction. As a result, bits (e.g., soft-bits) of the second network outputs 318 are converted into uplink data 322. In some implementations, decoding includes linear block code (LBC) decoding. For example, one or more software and/or hardware modules (e.g., a field-programmable gate array (FPGA) and/or application-specific integrated circuit (ASIC)) can implement a forward error correction (FEC) decoder algorithm such as a low-density parity-check (LDPC) code, which can be leveraged to perform soft-bit to codeword mapping. In some implementations, uplink data recovery 320 is performed at least partially using one or more neural networks trained to perform rate dematching, codeword mapping, decoding, and/or error correction.

The uplink data 322 is an estimate of data originally sent by user devices and received at the RU, such as media data, text data, voice data, requests for content, etc. The uplink data 322 can be passed to a destination device, such as one or more other network components and/or networks (e.g., via the Internet) as described with respect to (220). In some cases, data is received back from the other components of the RAN and/or one or more other networks 220. For example, downlink data can include responses to requests in the uplink data 322.

Although described as separate networks with respect to FIG. 3, in some implementations a single neural network can be configured to perform both channel estimation and symbol-demapping, e.g., including intervening steps. For example, a neural network (e.g., a fully-convolutional neural network) can be configured to perform channel estimation, grid multiplication, and symbol-demapping to obtain bit values, as part of the process 300 performing by the UL/PUSCH processing component 206.

FIG. 4 illustrates a process 400 of SRS processing for channel estimation, which may be performed, for example, by the SRS processing component 208 described with respect to FIG. 2. For example, the process 400 can be performed by the DU 104. The process 400 is performed based on SRS signal data, e.g., in the form of an SRS resource grid 402. The SRS resource grid 402 characterizes RF SRS signals sent from user devices to the RU. In the example of FIG. 4, SRS signals are received using multiple antennas, such that the SRS resource grid 402 is a three-dimensional tensor. The SRS resource grid 402 can correspond to the same RF reception configuration as the PUSCH resource grid 302, e.g., can have the same L, M, and K as the PUSCH resource grid 302. In some implementations, one or more of these parameters is different. For example, M may be different to alter a front-haul bandwidth (RU-DU bandwidth) associated with signal data transfer.

In the process 400, reference extraction 404, normalization 406, and/or demultiplication 408 (which are optional processes) can be performed generally as described for pilot extraction 304, normalization 306, and pilot demultiplication 308 in reference to FIG. 3. In reference extraction 404, reference symbols are extracted (and, in some implementations, de-interleaved) from the SRS resource grid 402. In normalization 406 (e.g., fast normalization or approximate normalization), one or more parameters of elements of the SRS resource grid 402, such as power, are normalized, e.g., as described for normalization 306. In reference demultiplication 408, known SRS sequences represented by the SRS resource grid 402 or other references sequences are demultiplied and/or de-rotated based on ground-truth values, e.g., as described for pilot demultiplication 308.

One or more channel estimation neural networks 410 are configured to recover a set of outputs 412 which reflect information about the transmitted symbols of the SRS resource grid 402 and/or channel statistics, such as the received amplitude and/or phase and/or the noise amplitude and/or variance across one or more locations in the SRS resource grid 402. For example, the outputs 412 can include CSI reflecting the current channel conditions between a user device and a MIMO antenna in order to be used for scheduling and beam-forming of transmissions to and from that user device. For example, the channel estimation neural networks 410 can be trained to implement a sparse regression across the SRS resource grid 402, e.g., one estimate per resource block (rather than, for example, one estimate per sub-carrier) for purposes of massive MIMO scheduling and beamforming operations, and/or another decimation rate of subcarriers and/or time in symbols. The outputs 412 include, or indicate (e.g., can be further processed to obtain), a channel estimate tensor/matrix H, e.g., for one or more mobile devices, as described for H in reference to FIG. 3. In some implementations, the outputs 412 include a full H estimate. In some implementations, the outputs 412 include an embedding of H or a sparse/compressed form of H from which H can be reconstructed.

In some cases, the H or other channel estimate in the network outputs 412 can be advantageous compared to H or other channel estimate obtained otherwise, e.g., based on PUSCH resource grids. For example, H from PUSCH resource grids can in some implementations be obtained by directly estimating H⁻¹ or W, which is a combination of H and sigma. The network outputs 412 can include a direct regression of H, in some implementations not including a noise contribution (sigma), which in some cases may be more useful/accurate for scheduling based on knowledge of the channel response. Also, in some cases the channel estimates in the network outputs 412 are smaller-size without significant corresponding reduction in accuracy/usefulness, such that the channel estimates in the network outputs 412 can be applied (e.g., for scheduling) with reduced latency/complexity. Further advantages associated with H in the network outputs 412, in some implementations, include wider bandwidth (K) and an advantageous lack of up-sampling to obtain one estimate per resource block in frequency and one estimate per slot in time as a sparse channel estimate.

The inputs to the channel estimation neural networks 410 can be similar to the inputs to the channel estimation neural networks 310 described above, e.g., full or partial SRS resource grids, in some cases preprocessed in one or more ways.

The network outputs 412 (e.g., H or an embedding/compressed form thereof) are sent (414) to one or more other RAN components, e.g., sent from the SRS processing component 208 in the L1 layer 204 to the L2 layer, e.g., the L2+ layer 212 for use in scheduling, as described in reference to FIG. 5. Providing an embedding/compressed form of H can reduce network resources consumed in the transmission compared to sending a full H in full-precision representation. In some implementations, an embedded/compressed form of H (which has, for example, a reduced storage size compared to H itself) can be obtained by providing a bottleneck layer as an intermediate layer in a network that determines channel estimates, such as network 310 and/or network 410. The bottleneck layer can have fewer nodes than prior layers so as to learn a representation of H that captures the majority of the information in H with a smaller dimension.

The one or more channel estimation neural networks 410 can have characteristics as described for the channel estimation neural networks 310. For example, the channel estimation neural networks 410 can be fully-convolutional neural networks so as to be capable of receiving scaling inputs, a capability that is particularly useful in the context of RF resource grid processing. The use of channel estimation neural networks 410 can provide the advantages discussed for the networks 310, 316 compared to, for example, algorithmic MMSE-based approaches to channel estimation based on SRS. In some implementations, a component such as the SRS processing component 208 or the RIC is configured to select between two or more channel estimation neural networks 410, as described for networks 310, 316 in reference to FIG. 3.

The channel estimation neural networks 410 can be trained as described for networks 310, 316 above. For example, estimated reference symbols output by the channel estimation neural networks 410 (or determined based on outputs of the channel estimation neural networks 410) based on SRS resource grids 402 can be compared to ground-truth reference symbols, with the difference represented by a loss function, and training can be performed so as to minimize the loss function. In some implementations, simulation is performed to model channel effects and obtain simulated labels for training data. As a result of the training, the neural networks 410 include a set of weights and parameters that configure the neural networks to perform channel estimation, e.g., when deployed in the L2 layer (such as in the DU).

FIGS. 3-4 describe neural network-based operations performed on RF signals received at a RAN architecture. The other side of RAN operation involves transmitting RF signals (downlink signals) to user devices. Operations associated with downlink transmission include scheduling (described with respect to FIG. 5) and beamforming (described with respect to FIG. 6). In some implementations according to this disclosure, one or both of these operations can be performed using one or more neural networks.

As shown in FIG. 5, a scheduling process 500, incorporating a neural scheduler 506, is based on respective traffic queues 502 and CSI 504 for two or more user devices. The process 500 can be performed, for example, by an L2 layer component, e.g., the DU 104 or the L2+ layer 212 component. Scheduling involves scheduling data transmissions for multiple user devices in a downlink resource grid and/or an uplink resource grid. Scheduling can be performed spatially and/or through the assignment of traffic or traffic grants to specific spectral resource blocks as well as, in some implementations, spatial directions and/or modes. This corresponds to a determination of how data is mapped across spectrum and space to provide target performance and quality of service (QOS) parameters for applications running over the scheduled data transmissions.

The traffic queues 502 include respective downlink data for transmission to each user device, e.g., in the form of packets with information about which user device is to receive which packets. In some implementations, further inputs to the neural scheduler include additional information associated with each traffic queue, e.g., indicating respective priorities, service levels, application types, and/or other properties associated with each downlink transmission to each user device. In some implementations, the downlink data is obtained as a result of a downlink data determination process after recovered uplink data is sent to other in-RAN and/or external components/networks (220). For example, the downlink data can be obtained from the Internet, e.g., with commands/instructions/labels indicating target user devices to receive different portions of downlink data.

The CSI 504 provides information about channel effects for downlink transmission to user devices receiving data in the traffic queues 502. The CSI 504 can include, for example, an H matrix/tensor, an approximation of H, and/or an embedding of H that allows for the reconstruction of H based on the embedding. For example, an H matrix/tensor, an approximation of H, and/or an embedding of H that allows for the reconstruction of H based on the embedding can be included in the CSI 504 for each user device. In some implementations, the CSI 504 includes channel estimates included and/or based on the first network outputs 312 and/or the network outputs 412. The channel estimates from the L1-layer processes of FIGS. 3-4 can be sent from the L1 layer 204 to a higher layer such as the L2+ layer 212 for scheduling. In some implementations, the CSI 504 includes CSI from one or more other sources, e.g., PUSCH receivers and/or predictive models; the inclusion of this data may improve channel estimation. The CSI 504 can at least partially determine scheduling outcomes, for example, because the efficiency and/or effectiveness of downlink signal transmission (e.g., spectral efficiency, signal-to-noise ratio (SNR), etc.) can depend on the channel effects.

The neural scheduler 506 (which can be hardware and/or software implemented, e.g., as a module of the DU 104) includes one or more neural networks configured to receive, as input, information corresponding to the traffic queues 502 and the CSI 504 (and, in some implementations, additional information as discussed below) and to output (as network predictions 508) a schedule for downlink transmission of the downlink data in the traffic queues 502 to the user devices, e.g., when, and with what spectral resources, the downlink data is to be transmitted to each user device. In some implementations, the one or more neural networks of the neural scheduler are configured to output the schedule based on optimization of a utility function based on one or more objectives (e.g., reducing latency, increasing multi-user throughput, and/or reducing interferences inside and/or outside the set of user devices receiving data).

Schedule determination can include consideration of, for example, rate selection; interference between spatial modes; interference between cells and/or sectors; interference from out-of-network sources or jamming, and/or other factors such as areas of non-radiation (e.g. airports or otherwise); requirements for quality of data transmission for one or more applications and/or services; the availability of delaying bursts for a user device; and/or which user devices can be co-scheduled. Data indicative of one or more of these conditions can be included in inputs to the neural networks of the neural scheduler 506, in various implementations. Further examples of types of data that can instead or additionally be included in inputs to the neural networks include traffic demand of each user device, queue depth for the queues 502, priorities of the queues 502, application types associated with the downlink data, and spatial information such as CSI, signal-to-noise ratio (SNR) for signals from the mobile devices, received signal strength indicators (RSSI) for signals from the mobile devices, mobility factors, and/or other properties associated with each user device and their recent and/or predicted throughput demands.

In at least some cases, this may be a computationally difficult problem to optimize directly (e.g., algorithmically for a single model-driven closed-form solution) while retaining low latency. Neural networks configured and trained as described herein, by contrast, can be configured to output schedules accurately and with low latency, in some implementations improving computational efficiency, latency, and/or transmission efficiency (e.g., power efficiency) compared to algorithmic approaches such as proportional-fair scheduling (PFS) and weighted fair queueing (WFQ) to balance data between different users. The neural networks of the neural scheduler 506 can be configured to rapidly and efficiently digest many different types of scheduling inputs as well as a number of different scheduling performance loss metrics into, for example, a single aggregate tunable loss function, in order to arrive at a compact low-latency scheduling algorithm which can optimize very effectively within a complex optimization function of numerous factors which may vary over time, equipment, operator, location, application, and/or other factors.

A schedule output by the neural scheduler 506 can have various forms, such as a set of resource assignments. The schedule reflects a set of traffic/bursts/allocations for downlink emissions across a set of spectral and spatial resources. For example, the schedule can assign which bursts occur at which time-and-frequency resource grid location and/or which user device(s) may be co-scheduled across the same time-and-frequency resources in different spatial dimensions. In some implementations, the network predictions 508 directly include scheduling assignments 510. In some implementations, the network predictions 508 can be used (e.g., by the component executing the neural scheduler 506) to determine the scheduling assignments 510, e.g., based on features, such as user device pairings, included in the network predictions 508.

In some implementations, the neural networks of the neural scheduler 506 are trained to predict one or more mappings which can be used within the neural scheduler to determine the schedule. For example, the neural networks can be trained to predict ideal multi-user pairings of user devices for scheduling, and/or to perform a regression (such as a water-filling regression) towards optimal best time-frequency and/or spatial mappings, e.g., by predicting one or more quality metrics for the time-frequency and/or spatial mappings. In some implementations, the neural networks are trained to implement a mapping of user devices into spectral and spatial resources.

Training of the one or more neural networks of the neural scheduler 506 can be performed by the training component 110 or 230, e.g., by one or more applications executing on the RIC 112. In some implementations, the neural networks are trained based on a policy engine such as reinforcement learning, e.g., treating the scheduling process as an observation space in which discrete actions constitute mappings of users into spectral and spatial resources. For example, the neural networks can be trained to perform an action-selection process to determine the schedule. In some implementations, the one or more neural networks are trained to predict one or more specific features associated with scheduling, such as user device pairings. Training can be performed using training data such as one or more schedules and/or features thereof labeled with one or more key performance indicators (KPIs) characterizing downlink transmission based on the schedules and/or features thereof. The neural networks can be trained to determine schedules and/or features thereof so as to improve the KPIs. For example, the KPIs can include a measure of throughput (e.g., the sum rate), a measure of latency, a measure of power consumption, etc. As a result of the training, the neural networks of the neural scheduler 506 include a set of weights and parameters that configure the neural networks to perform scheduling, e.g., when deployed in the L2 layer (such as in the DU).

Downlink transmission is performed according to the schedule, e.g., by controlling multiple antennas of the RU 102 or RU 202 to transmit RF signals encoding the downlink data to user devices according to a time-and-frequency resource grid. The multiple antennas are controlled based on a set of beamforming weights to direct the RF signals to target user devices to increase SNR and reduce interference.

As shown in FIG. 6, a beamforming process 600 incorporates a neural beam predictor 606 including one or more neural networks configured to determine, as outputs, beamforming weights 608 based on which multiple antennas of the RU 102 or RU 202 are controlled. The beamforming weights 608 can be used to map M antenna elements into a specific number of information streams or layers for transmission. Inputs to the neural networks include channel state information 602 (e.g., H or an embedding/representation thereof) for each user device that is to receive a downlink RF signal. The channel state information 602 can be, for example, the channel state information 504 described with respect to FIG. 5. For example, the channel state information 602 can include and/or be derived from the first network outputs 312 and/or the network outputs 412, such as H for each user device.

Some existing methods for beamforming calculation are based on algorithms such as a zero-forcing (ZF) beam-weight calculation algorithm, which takes in channel estimates for each layer and/or user device and produces a set of weights that separates or combines transmissions spatially given the M antennas. These closed-form beam-weight computation methods can take into account certain parameters such as antenna arrangement/configuration, the types of antenna elements, the frequency of operation, and/or other propagation or materials properties. However, some existing algorithmic methods fail to account for additional information which can, in some implementations, be provided as input to the neural networks. This additional information can include, for example, the CSI 602. In some implementations, the additional information provided as input to the neural networks includes additional information 604, including one or more of: non-user spatial information, e.g., about interferers, jammers, etc.; conditions in adjacent sectors; channel gains and/or modulation coding scheme (MCS) selections for each layer N (the number of unique transmit symbol streams a user device transmits simultaneously on each time-frequency resource, or multiple user devices transmit simultaneously in MU-MIMO systems); noise estimation or power levels for each stream; geometric information about beam propagation; user behavior information; the quality and/or stability of channel estimates and/or noise estimates for each layer; property targets such as quality of service (QoS) and/or assurance for each transmission; spatial direction(s) of region(s) desired and/or undesired for transmission; and/or distributions of spatial information such as typical user locality or direction or path.

In addition, some existing algorithmic approaches rely on specific antenna geometries, whereas, in some implementations, the neural networks of the neural beam predictor 606 are configured to take into account (e.g., as additional information 604) additional antenna parameters such as non-normal area correlation, coupling, and/or propagation effects which may otherwise be prohibitively difficult (e.g., computationally expensive) to model in closed form.

Based on this and/or other information, the consideration of which may be incompatible with algorithmic approaches to beamforming, in some implementations the neural beam predictor 606 can provide more-flexible and better-performing massive MIMO systems across diverse spectrum activity, antenna configurations, etc. For example, power consumption, signal interference, and/or latency can be improved based on the use of the neural networks described herein.

In some implementations, the one or more neural networks of the neural beam predictor 606 are configured to receive, as input, schedule information 616, e.g., the scheduling assignments 510. For example, the scheduling assignments 510 can indicate that a set of user devices are to be co-scheduled, and the neural networks can be configured to, based on the scheduling assignments, determine a set of beam weights that result in co-scheduled downlink transmission to the set of user devices, e.g., with target low levels of predicted interference.

As discussed in reference to FIG. 2, the beamforming process 600 can be performed by an L1 component such as the DU 104. The beamforming weights 608 can be provided to a transmitting unit, such as the RU 102, 202, to determine RF signal transmission.

Training of the one or more neural networks of the neural beam predictor 606 can be performed by the training component 110 or 230, e.g., by one or more applications executing on the RIC 112. Training can be performed using training data such as sets of beamforming weights for transmission to user devices, corresponding CSI characterizing channels to the user devices, and, in some implementations, additional information (such as the types of information described above for other information 604. This training data can be labeled with one or more KPIs characterizing downlink transmission based on the beamforming weights. The KPIs can include, for example, a measure of performance loss, such as a bit error rate. The neural networks can be trained to determine beamforming weights so as to improve the KPIs. As a result of the training, the neural networks of the neural beam predictor 606 include a set of weights and parameters that configure the neural networks to perform scheduling, e.g., when deployed in the L1 layer (such as in the RU).

The neural networks of the neural beam predictor 606 can have various configurations in different implementations. In some implementations, the neural networks are deep neural networks, e.g., densely-connected networks which can perform significant intermixing and approximation of inverse operations, and which can combine convolutional elements across layers, e.g., across time or frequency, where significant locality or correlation may exist. The neural beam predictor 606 performs a function analogous in some aspects to a matrix inversion. Accordingly, in some cases, the beam solution (outs of the neural beam predictor 606) depends heavily on all inputs to the neural beam predictor 606, such that, for purposes of this disclosure, it has been recognized that input mixing can be advantageous. Input mixing can include (i) pre-processing of the inputs to provide mixing (i.e. eigen-decomposition, factorization, and/or inversion, etc.) and/or (ii) training the neural network mix inputs, e.g., using a network with fully connected elements such as dense connections or convmixer patch mixing, which provide a high degree of combinatorial mixing power to attain an architecture which has an appropriate level of mixing to approximate an effective beam weight estimation function.

Retraining/optimization can be performed based on a feedback arrangement, as shown by element 618 in FIG. 6. For example, measured KPIs can be used to adjust parameters of the neural networks of the neural beam predictor 606. In some implementations, a simulation-based approach is used. The results of beamforming weights 608 output by the neural beam predictor 606 can be simulated (e.g., by modeling channel effects using a digital twin), and parameters of the models can be adjusted to improve these simulated results, where the results can include various KPIs, such as SNR. The beamforming simulations 610 can include environmental simulations driven by models and/or data to reflect the performance from deployed systems, and in some cases the simulations 610 can be altered based on real-world feedback data, e.g., to obtain more accurate simulation results by matching simulated effects to measured real-world effects. In some implementations, user simulations 612 can be used, e.g., to simulate interferences measurement at user device spatial locations and/or sectors for input into a loss computation. Other metrics that can be simulated include, for example, bit error rate (BER), error vector magnitude (EVM), and/or block error rate (BLER), e.g., for simulated user devices based on beamforming weights 608. Simulated metrics/results of the simulations 610 and/or 612 are used for loss computations in the retraining process for neural network adjustment (618), reducing/minimizing the loss, and helping to optimize a set of weights, parameters and/or architecture which together provide a compact non-linear neural beamformer. These simulation methods can instead or additionally be used in initial training of the neural beam predictor 606.

FIG. 7 illustrates an example of an architecture 700 for deployment of one or more of the neural networks described herein in a RAN. In the architecture 700, execution of trained neural networks (e.g., performance of processes 300, 400, 500, and/or 600) is performed in the L1 layer at a DU 702 (in this example, an O-DU of an OpenRAN deployment), while training and/or retraining (tuning) of the neural networks is performed in a near real-time RIC 704. The DU 702 can have characteristics as described for the DU 104, and the near real-time RIC 704 can have characteristics as described for the MC 112. Although described as a near real-time MC, the MC 704 can be another RIC, e.g., a non real-time MC, without departing from the scope of this disclosure.

The architecture 700 facilitates high-frequency or continuous monitoring, training, and optimization of components of the neural receiver 710. The neural receiver 710 can include one or more neural networks described herein, such as channel estimation neural networks 310, 410, symbol-demapping neural networks 316, neural networks of the neural scheduler 506, and/or neural networks of the neural beam predictor 606. For example, the neural receiver 710 can be a software and/or hardware module configured to perform at least one of processes 300, 400, 500, or 600 using neural networks.

In an example of a retraining process, the neural receiver 710 receives input data such as PUSCH/DMRS resource grids 706 (e.g., for use in process 300) and/or SRS sounding resource grids 708 (e.g., for use in process 400). Although not shown in FIG. 7, the neural receiver 710 can instead or additionally receive other input data associated with other processes described herein, such as queues and CSI information as shown in FIG. 5, and/or CSI information, schedule information, and other information as shown in FIG. 6, for corresponding retraining of the neural networks of FIGS. 5 and/or 6.

The neural receiver 710 provides outputs such as first network outputs 312, second network outputs 318, network outputs 412, network predictions 508, and/or beamforming weights 608. The outputs need not (though can be) direct outputs of the neural networks. For example, in some implementations the outputs are based on neural network outputs, e.g., include uplink data 322, scheduling assignments 510, etc. These outputs can be provided to the RIC 704 over an appropriate RAN interface. In the example of FIG. 7, an E2 agent 716 of the E2 interface handles the data transfer. For example, the E2 agent 716 can provide an API and/or service model by which application of the MC 704 can communicate with the DU 702 to obtain data. In addition, the inputs to the neural receiver 710, such as the resource grids 706 and/or 708, can in some implementations be provided to the RIC 704. These reflect real measured channel responses and statistics. In some implementations, the MC 704 further obtains performance indicators, such as throughput, latency/round trip time (RTT), CQI, sum-rate, average rates, modulation and coding scheme (MCS) modes, BLER statistics, call drop rates, RSSI and/or signal-interference+noise ratio (SINR) statistics, etc.

The RIC 704, in this example, hosts a neural generative channel modeling xApp 714 and a neural receiver training and tuning xApp 712, which can be configured to perform one or more functions. In some implementations, the xApps 712 and/or 714 are configured to perform signal archival, e.g., storage of grids 706 and/or 708. The xApp 712 is configured to provide training and model updates to the neural network(s) of the neural receiver 710, e.g., by providing updated model parameters, model weights, and/or model architectures or other metadata. For example, based on the received resource grids and performance indicators that reflect the real-world results of channel estimation, scheduling, beamforming, etc., using the neural networks, the xApp 712 can be configured to update the neural networks to improve future performance indicators. Accordingly, the xApp 712 can periodically and/or on-demand provide model updates to the DU 702 to update the neural receiver models to continually improve their performance and to fine-tune them for improved performance in their deployed conditions. The applications 712, 714 need not be xApps but can be, for example, zApps or rApps.

In some implementations, retraining is associated with an encoding/decoder. For example, the output of an FEC decoder may be used as a loss metric for retraining neural networks 310 and/or 316. Various input data may be permuted using a variety of gradient based or gradient free methods such as adding perturbation noise to the input, output or intermediate stages to create synthetic gradients. In such a way, these networks may be fine-tuned to obtain the best performance in terms of one or more performance metrics of the resulting system and may be readily deployed and tuned to provide excellent performance within a real-world system, implementation, and/or environment.

In some implementations, the xApp 712 performs neural network training, e.g., initial training, which may be distinct from retraining of already-deployed neural networks. Training can be performed as discussed with respect to each of FIGS. 3, 4, 5, and 6. The training can include simulation-based training to generate training data and corresponding labels, as discussed in reference to xApp 714.

As described above in the context of neural networks 310, 316, in some implementations, the neural receiver training and tuning xApp 712 is configured to select, load, and/or change out aspects of the neural receiver 710. For example, based on inputs such as cell statistics, cell usage, events or predicted events, load changes, coverage changes, and/or other network conditions, the xApp 712 can select between different neural networks to be included or used in the neural receiver 710. The alternative neural networks may provide a benefit based on prior data and training. For example, as described above in the context of neural networks 310, 316, in some cases a tradeoff between latency and accuracy is associated with network size. The xApp 712 can be configured to select between a larger, higher-latency versions and smaller, lower-latency versions of neural networks 310, 316, 410, neural networks in the neural scheduler 506, and/or neural networks in the neural beam predictor 606, based on one or more of the aforementioned inputs. In some implementations, based on selecting a particular neural network, the xApp 712 is configured to send the neural network to the DU 702, e.g., over the E2 interface as illustrated

The (optional) xApp 714 is configured to perform generative channel modeling and/or simulation. This can represent an expansion of the retraining data provided by the DU 702. For example, given a set of real-world resource grids 706 and/or 708 provided by the DU 702, the xApp 714 can be trained (e.g., as a generative adversarial network (GAN)) to produce additional resource grids drawn from the distribution of the real-world resource grids. The xApp 714 need not be neural network-based. For example, in some implementations, the xApp 714 is configured to perform simulations based on a measured distribution, e.g., a delay-spread distribution or a Doppler distribution; the outputs of the simulations are simulated results of signal processing that reflect the distribution and that can be used as training/retraining data by the xApp 712. For example, the xApp 714 can provide/obtain an as-transmitted resource grid and simulate transmission of a signal corresponding to the resource grid through many different channels, to obtain training data (the channel-altered values of the resource grids) and corresponding labels (the original resource grid) under many different channel conditions. The channel conditions can include, for example, a distribution that reflects real-world propagation, multi-path, spatial, and usage distributions. Accordingly, in some cases, this generative modeling can be referred to as digital-twin modeling, in which real-world observations of signals and/or CSI are used to construct twin generative models that simulate and produce realistic simulated real-world observations.

As a non-limiting example of training, a generative model (e.g., executing in an xApp) is trained on channel distributions of power delay profiles (PDPs) associated with channels, based on measurement of DMRS reference tones. Simulated outputs of the generative model include synthetic channel variates. These outputs are used to train one or more neural networks, such as channel estimation neural networks, symbol-demapping neural networks, scheduling neural networks, and/or beamforming neural networks, to obtain neural networks that are optimized to estimate channel effects in, recovery data from, determine beamforming weights in, etc., an environment sharing the channel distributions.

The architecture 700 represents an efficient and effective allocation of functions in the context of RANs. Based on execution on the DU 702, the neural receiver 710 can operate with low latency and with fast provision of/access to signal samples, scheduling information, beamforming weights, etc., to/from a radio unit over a front-haul link, in accordance with desired rapid signal processing, reception, and transmission functions. Meanwhile, computationally-intensive network training/retraining is performed at the RIC 704, which may have access to greater computational resources than the DU 702, so as to not interfere with low-latency operations of the DU 702. As network training/retraining may not have very-low latency requirements, these operations are suitable for performance by the RIC 704.

Instead of or in addition to execution in the RIC 704, training/retraining can be performed in one or more other computing systems, e.g., a cloud computing system in communication with the RAN.

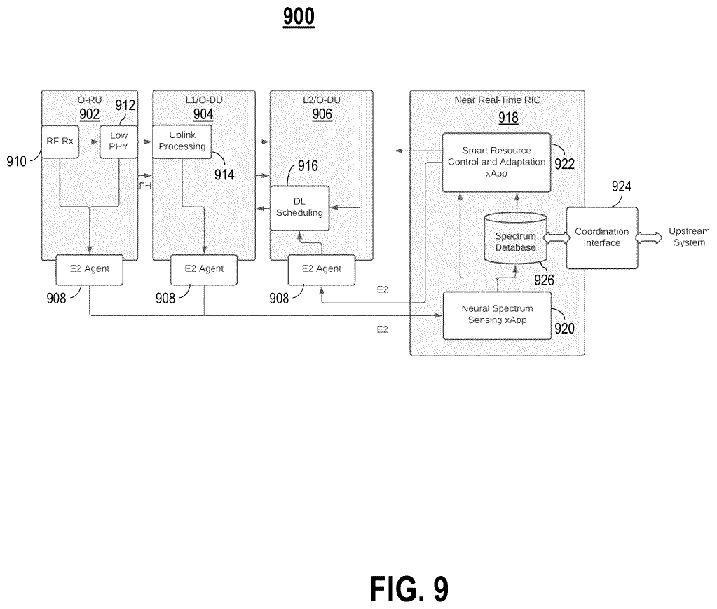

FIG. 8 illustrates an example of a process 800 for simulation based training. The process 800 can be performed, for example, by one or more applications executing on a RIC, such as MC 112. An estimator (such as any of the neural networks described in reference to FIGS. 3-6) is trained (802) based on simulation, e.g., using simulations to model various channel effects on original RF data (e.g., in resource grid form) to obtain simulated modified data, and then using neural networks' estimates of the original RF data (in comparison to the actual original RF data) to modify the parameters of the neural networks. The simulated channel effects can be from a synthetic scenario and/or from a data-driven scenario reflecting an intended deployment environment A model including the trained one or more neural networks) is deployed to a cell site or radio (804), e.g., is sent to a DU in a base station.

In some implementations, the initially-trained model is a generic starting model that is trained to perform satisfactorily in a range of environments and channel conditions (e.g. both high-Doppler and high-delay-spread fading conditions within a cellular environment). This neural inference model is then deployed into the RAN to perform its respective functions. Subsequent updating of the generic starting model based on real-world observations will result in the model being fine-tuned for its particular context, e.g., load, channel effects, etc.

The model is updated based on a mixture of measured ground truth and simulation (806) and/or based on sparse ground truth, such as pilots (808). Updating based on a mixture of measured ground truth and simulation (806) can be performed, for example, as described for xApp 714 and as described in reference to training the neural networks 310 and/or 316. For example, data values of resource grids (as opposed to only pilot values of the resource grids) can be used for retraining, e.g., in simulated and/or reconstructed form.

Updating based on sparse ground truth (808) can be performed as described for pilot-based training in reference to neural networks 310 and/or 316, e.g., based on pilot symbols or reference symbols of the resource grids 302, 402, for which ground-truth values are known. For example, a loss function based on the sparse DMRS estimates of an output-equalized signal (as opposed to all data and reference signal estimates) can be used to train and update the model without requiring ground-truth knowledge about all of the data symbols or bits transmitted (e.g., about every element of the resource grid). Training and/or retraining based on sparse data can reduce complexity in training (e.g., reducing computational resources consumed and/or increasing training speed), to facilitate easier deployment and/or online tuning of neural networks such as networks 310, 316, and 410 in cases where wireless signals incorporate pilot signals, reference signals, or sounding signals.

Accordingly, model parameters, model weights, and/or model architectures can be adjusted for improved model performance, resulting in, for exampled, reduced latency, reduced power consumption, improved spectral efficiency, reduced RF signal interference, increased SNR, etc.

In some implementations, real-world data used for retraining is drawn from an archive, e.g., an archive in which xApps 712 and/or 714 have stored resource grids, such as the spectrum database 926.

FIG. 9 illustrates an example of further neural network-based processing in a RAN. In this case, one or more neural networks execute in a RIC (e.g., RIC 112) to perform spectrum analysis. As shown in FIG. 9, a RAN architecture 900 includes an RU 902 (e.g., having characteristics as described for RU 102 and/or 202), an L1 layer 904 of a DU (e.g., having characteristics as described for DU 104 and/or 702), an L2 layer 904 of the DU, and a MC 918 (e.g., having characteristics as described for MC 112 and/or 704). In this non-limiting example, the MC 918 is a near real-time RIC. Also, in this example, the RAN architecture 900 is an OpenRAN architecture.

RF signals are received at an RF receiver 910 of the RU 902. Samples of the RF signals (e.g., in the form of a resource grid) are provided to the L1 layer 904 via a low PHY module of the RU 902 and a fronthaul (FH) link. An uplink signal processing module 914 of the L1 layer 904 can be (but need not be) configured to perform uplink signal processing using one or more neural networks, e.g., as described in reference to FIGS. 3-4. Outputs of the uplink signal processing module 914 (including, e.g., recovered uplink data, channel estimates, etc.) are sent to the L2 layer 906. A downlink scheduling component 916 of the DU is configured to perform scheduling, optionally using one or more neural networks as described in reference to FIG. 5.

A neural spectrum sensing xApp 920 receives RF signal data from the air-interface or from the front-haul, e.g., using an E2 agent 908. For example, the RF signal data can include received information, RF samples, and/or resource grids. The neural spectrum sensing xApp 920 is configured to process the received RF information using one or more neural networks to perform signal detection, segmentation, classification, and/or other estimation functions. As a result, the neural spectrum sensing xApp 920 is configured to output information describing RF emissions within an observed region of received air-interface data, e.g., within a defined frequency band. For example, the xApp 920 can be configured to output high-level descriptive information about radio activities, such as identifications of wireless attacks, exploitation attempts, jamming, interference, radar events, hardware failures, malfunction events, and/or electromagnetic interference (EMI) from nearby electronics or equipment which might interfere with, disrupt, or threaten the RAN architecture 900.

In some implementations, the xApp 920 is configured to store this output information in a spectrum database 926. In some implementations, the spectrum database 926 stores a series of archived power delay profiles (PDPs) and/or channel responses which have been received within uplink PUSCH or SRS transmission from one or more cells or sectors. The spectrum database 926 can be configured for upstream peering through a coordination interface 924, e.g., for further analysis of the output information. Accordingly, RF event and other information can be shared across cells, networks, and/or other systems. In some cases, a federal spectrum access system (SAS) or other spectrum-sharing services at a national, governmental, or inter-operator/inter-network coordination level can share information about RF events, emitter types, locations, power levels, etc., e.g., using the coordination interface 924. Accordingly, coordinated resource management can be conducted over multiple cells/networks.

In some implementations, the xApp 920 is configured to perform RF signal analysis as described in U.S. application Ser. No. 18/113,201 (e.g., as described in reference to machine learning sensing systems (MLSS)), the entirety of which is incorporated herein by reference.

In some implementations, a smart resource control and adaptation xApp 922 is configured to use one or more neural networks to process (as inputs) outputs of the neural spectrum sensing xApp 920, e.g., the event and other information described above. The xApp 922, in some implementations, takes as input information from the spectrum database 926, at least some of which may be drawn from other networks. The smart resource and control adaptation xApp 922 is configured to use and/or create rule-based and/or learned policies that dictate responses to take within the RAN architecture 900, e.g., particular configurations of RAN operation. For example, the xApp 922 can be configured to output E2 or other interface messages to control cell parameters such as frequency bands, power levels, and/or antenna tilts. In some implementations, the xApp 922 is configured to output messages to the L2 layer 906 of the DU (e.g., using the E2 interface) to control scheduling of resources in spectral and/or spatial dimensions, e.g., which can control operations of the downlink scheduling component 916. These messages can, for example, dictate the avoidance of certain time and/or frequency intervals which are known to have interference or which should be avoided for other reasons. As another example, the messages can include spatial information about interferers or other locations in space which should be avoided or suppressed during spatial processing or towards which it is desired to minimize or maximize the radiation of various energy within the RAN system. In some implementations, one or more of these outputs can be provided to the L1 layer, e.g., for beamforming weight determination. For example, one or more of these outputs can be provided as inputs to processes 500 and/or 600 (e.g., as other information 604). Examples of how outputs of the xApp 922 can at least partially determine RAN operations are discussed in U.S. application Ser. No. 18/113,201.

The use of xApps (or other application types, such as zApps/rApps) as described for the xApps 920, 922 can provide low-latency sensing of spectral across a wide range of RU platforms and rapid distillation of raw RF data into high-level information that can be shared with peers and coordinating entities. This high-level information can be rapidly acted upon using, for example, the near real-time capabilities of the RIC 918 and the E2 interface to optimize, protect, or otherwise direct the RAN's efficiency in either dedicated or shared spectrum bands.

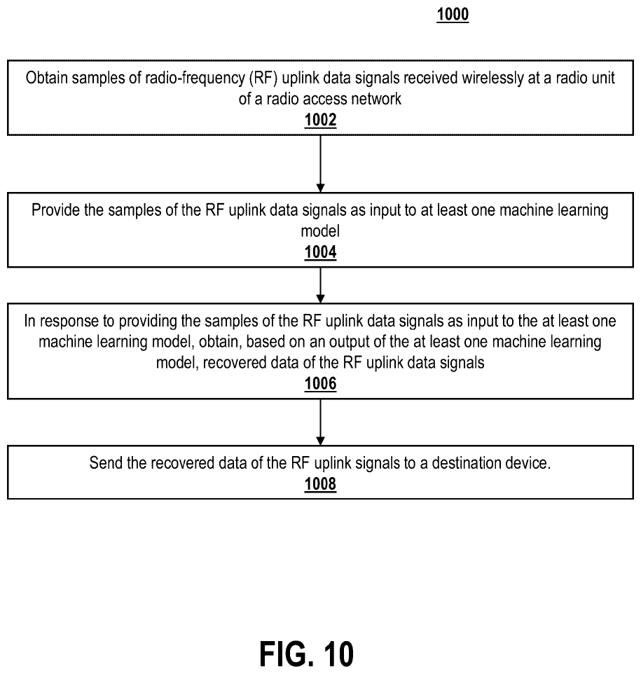

FIG. 10 illustrates an example of a process 1000 for data recovery, e.g., from uplink RF signals. The process 1000 relates to the process 300 described with respect to FIG. 3. The process 1000 can be performed, for example, wholly or partially by a DU and/or RU of a cellular base station (e.g., RU 102 or 202 and/or DU 104), and/or by one or more other RAN components. In the process 1000, samples of radio-frequency (RF) uplink data signals received wirelessly at a radio unit of a radio access network are obtained (1002). For example, the samples of RF uplink data signals can be resource grids (e.g., whole or partial grids 302). The samples of the RF uplink data signals are provided as input to at least one machine learning model (1004). The at least one machine learning model can include, for example, neural networks 310 and/or 316. In response to providing the samples of the RF uplink data signals as input to the at least one machine learning model, based on an output of the at least one machine learning model, recovered data of the RF uplink data signals are obtained (1006). For example, the at least one machine learning model can output channel estimates and/or inferred bits, and the recovered data can be a result of codeword mapping, decoding, and error correction based on the inferred bits.

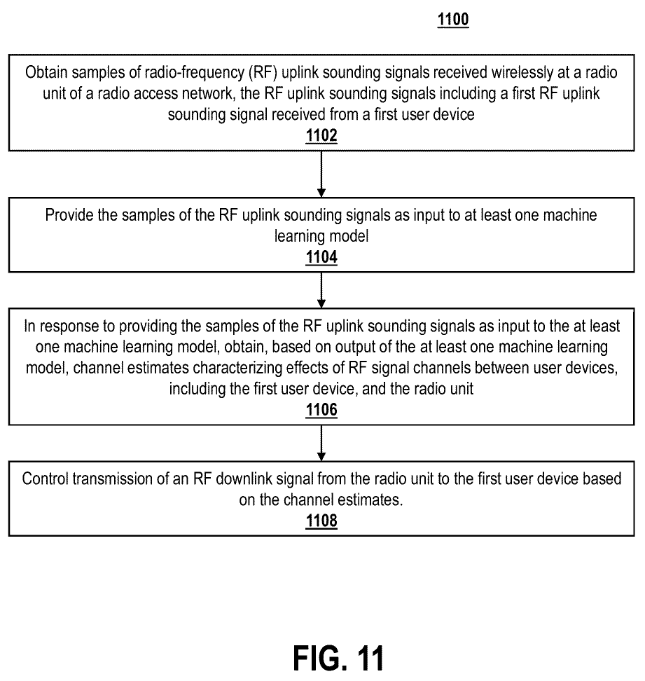

FIG. 11 illustrates an example of a process 1100 for channel estimation, e.g., based on uplink RF sounding/reference signals. The process 1100 relates to the process 400 described with respect to FIG. 4. The process 1100 can be performed, for example, wholly or partially by a DU and/or RU of a cellular base station (e.g., RU 102 or 202 and/or DU 104), and/or by one or more other RAN components. In the process 1100, samples of radio-frequency (RF) uplink sounding signals received wirelessly at a radio unit of a radio access network are obtained, the RF uplink sounding signals including a first RF uplink sounding signal received from a first user device (1102). For example, the samples of RF uplink sounding signals can be resource grids (e.g., whole or partial grids 402). The samples of the RF uplink sounding signals are provided as input to at least one machine learning model (1104). The at least one machine learning model can include, for example, neural network 410. In response to providing the samples of the RF uplink sounding signals as input to the at least one machine learning model, based on output of the at least one machine learning model, channel estimates are obtained characterizing effects of RF signal channels between user devices, including the first user device, and the radio unit (1106). The channel estimates can include, for example, H, W, sigma, or a combination or derivative thereof. Transmission of an RF downlink signal from the radio unit to the first user device is controlled based on the channel estimates (1108). For example, the channel estimates can be used to determine beamforming weights and/or scheduling for transmission to the first user device, resulting in different signals provided to antennas for the downlink transmission.

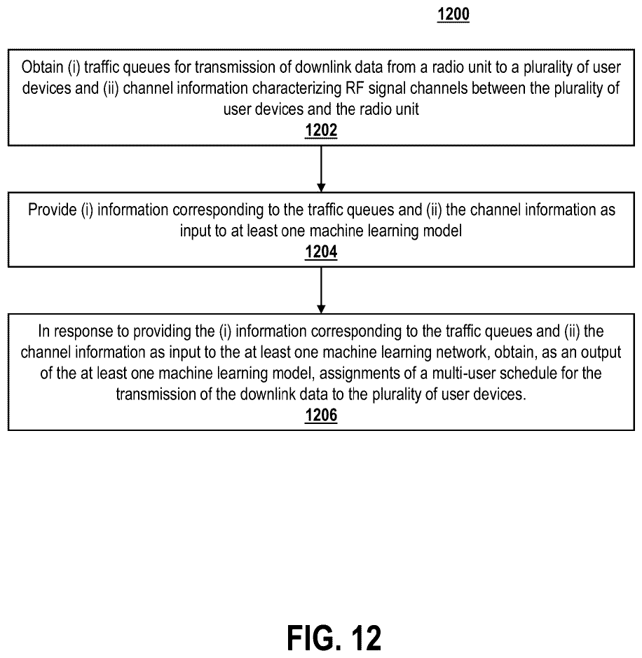

FIG. 12 illustrates an example of a process 1200 for scheduling downlink signal transmission to user devices from a radio unit. The process 1200 relates to the process 500 described with respect to FIG. 5. The process 1200 can be performed, for example, wholly or partially by a DU and/or RU of a cellular base station (e.g., RU 102 or 202 and/or DU 104), and/or by one or more other RAN components. In the process 1200, (i) traffic queues for transmission of downlink data from a radio unit to a plurality of user devices and (ii) channel information characterizing RF signal channels between the plurality of user devices and the radio unit are obtained (1202). (i) Information corresponding to the traffic queues and (ii) the channel information are provided as input to at least one machine learning model (1204). The channel information can included, for example, an estimated H or derivative thereof, and the information corresponding to the traffic queues can include, for example, any or all of the information described above as being input to the neural scheduler 506. The at least one machine learning model can include the neural scheduler 506. In response to providing the (i) information corresponding to the traffic queues and (ii) the channel information as input to the at least one machine learning model, as an output of the at least one machine learning model, assignments are obtained of a multi-user schedule for the transmission of the downlink data to the plurality of user devices (1206). The assignments can be used for subsequent control of one or more antennas, the use of various spectra for different user devices, etc., for low-interference and efficient downlink transmission.

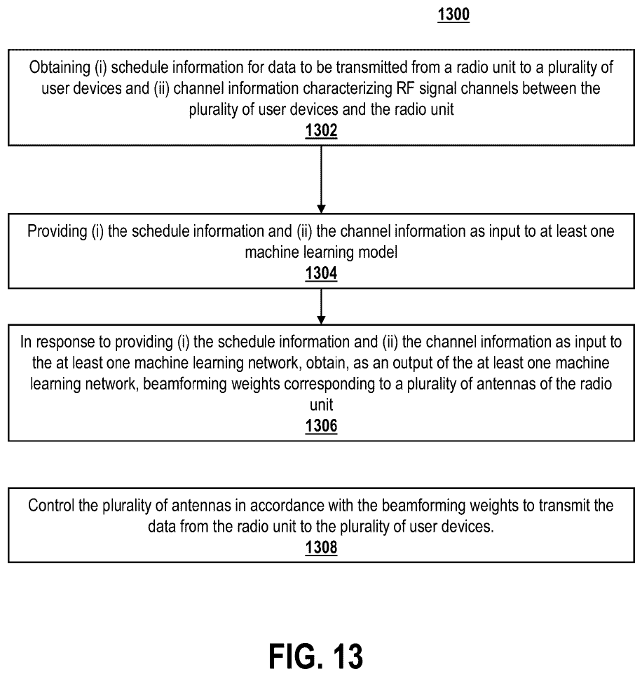

FIG. 13 illustrates an example of a process 1300 for beamforming determination for downlink signal transmission to user devices from a radio unit. The process 1300 relates to the process 600 described with respect to FIG. 6. The process 1300 can be performed, for example, wholly or partially by a DU and/or RU of a cellular base station (e.g., RU 102 or 202 and/or DU 104), and/or by one or more other RAN components. In the process 1300, (i) schedule information for data to be transmitted from a radio unit to a plurality of user devices and (ii) channel information characterizing RF signal channels between the plurality of user devices and the radio unit are obtained (1302). The schedule information can indicate, for example, respective resources to be used for downlink transmission to user devices, and the channel information can include channel estimates such as H. (i) the schedule information and (ii) the channel information are provided as input to at least one machine learning model (1304). The at least one machine learning model can include, for example, a neural network of the neural beam predictor 606. In response to providing (i) the schedule information and (ii) the channel information as input to the at least one machine learning model, as an output of the at least one machine learning model, beamforming weights are obtained corresponding to a plurality of antennas of the radio unit (1306). The plurality of antennas are controlled in accordance with the beamforming weights to transmit the data from the radio unit to the plurality of user devices (1308).

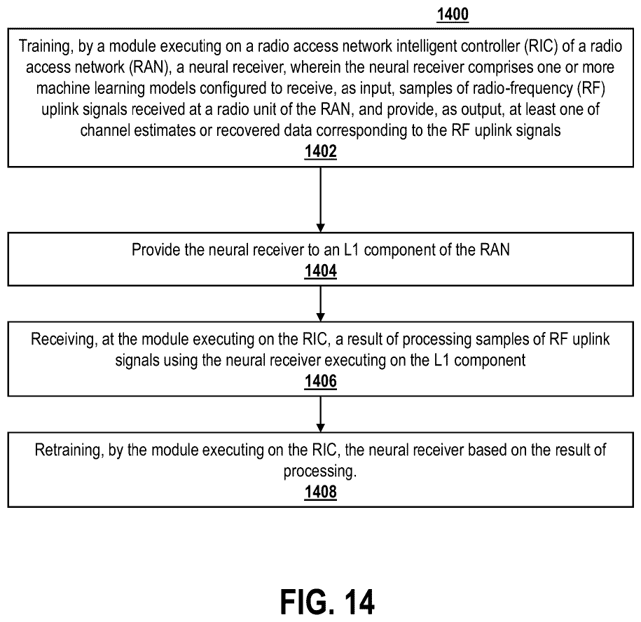

FIG. 14 illustrates an example of a process 1400 for machine learning model training. The process 1400 relates to the architecture 700 described with respect to FIG. 7. The process 1400 can be performed, for example, by an xApp, rApp, or zApp of a MC, such as RIC 112 or RIC 704. In the process 1400, a module executing on a radio access network intelligent controller (RIC) of a radio access network (RAN) trains a neural receiver (14). The neural receiver includes one or more machine learning models configured to receive, as input, samples of radio-frequency (RF) uplink signals received at a radio unit of the RAN, and provide, as output, at least one of channel estimates or recovered data corresponding to the RF uplink signals. For example, the machine learning models can include networks 310, 316, and/or 410. The neural receiver is provided to an L1 component of the RAN (1404). The L1 component can include, for example, the RU and/or DU of the RAN. At the module executing on the RIC, a result of processing samples of RF uplink signals using the neural receiver executing on the L1 component is received (1406). The result can include, for example, indicators of accuracy/quality of channel estimation, data recovery, etc. The neural receiver is retrained based on the result of processing (1408). For example, a loss function can be used to modify weights/parameters of one or more neural networks of the neural receiver.

The process 1400 and the architectures associated with the process 1400, including the description provided with respect to FIGS. 7-9, can be applied to training/retraining of any of the neural networks described herein, including not only the networks 310, 316, and 410 but also models of the neural scheduler 506 and the neural beam predictor 606.

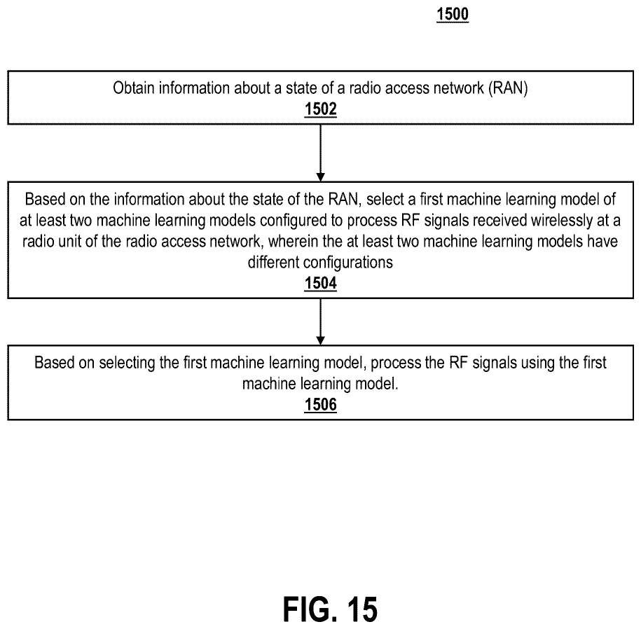

FIG. 15 illustrates an example of a process 1500 for model selection. The process 1500 can be performed, for example, by an xApp, rApp, or zApp of a MC, such as MC 112 or MC 704, and/or by an RU and/or DU (e.g., RU 102 or 202 and/or DU 104), and/or by one or more other RAN components. In the process 1500, information is obtained about a state of a radio access network (RAN) (1502). The information can indicate, for example, a current load on the RAN, a number of user devices served by the RAN, spatial and/or other information about an environment of the RAN, etc. Based on the information about the state of the RAN, a first machine learning model of at least two machine learning models configured to process RF signals received wirelessly at a radio unit of the radio access network is selected (1504). The at least two machine learning models have different configurations. For example, the machine learning models can have different sizes. Based on selecting the first machine learning model, the RF signals are processed using the first machine learning model (1506). For example, the first machine learning model can be provided from a RIC to a DU and/or RU for use in signal processing.

Although the above description sometimes refers to PUSCH processes, the described processes, configurations of neural networks, methods of neural network training/retraining, transfer of data with the RAN architecture, etc., can be applied to other channels, such as the physical uplink control channel (PUCCH) and the physical random access channel (PRACH).

In addition, although the above description refers to RAN-side processes in which RF signals are received from user devices and transmitted to user devices, in some implementations, the described processes, configurations of neural networks, and methods of neural network training/retraining can be performed on a user device (e.g., a smartphone, a wearable device, a personal computer, a connected vehicle, etc.), for receiving RF signals from a RAN RU and/or transmitting RF signals to a RAN RU. For example, for device-side processing, the above-described uplink signal processing can instead be downlink processing. For example, instead of input data being a sample of an uplink RF signal (e.g., a PUSCH resource grid), the input data can be a sample of a downlink RF signal (e.g., a resource grid of a downlink channel such as the physical downlink shared channel (PDSCH), the physical downlink control channel (PDCCH), or a downlink sounding signal for the process 400). In device-side processing implementations, processes 300, 400, 500, 600, 1000, 1100, 1200, 1300, 1400, and/or 1500 can be performed by one or more software and/or hardware modules of a user device. The above-described channel estimation and data recovery for received uplink signals is instead performed for received downlink signals, and the above-described scheduling and beamforming operations for downlink signals are instead performed for uplink signals from the user device to another device, such as a radio unit of a cellular base station.

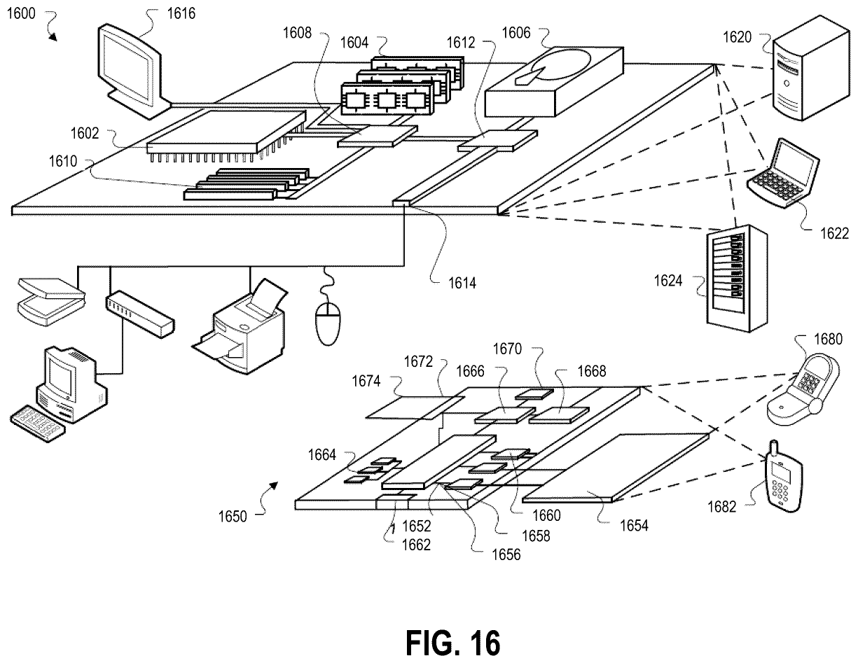

FIG. 16 is a diagram illustrating an example of a computing system that may be used to implement one or more components of a system that utilizes neural networks for RF system operations. The computer system illustrated in FIG. 16 can be, or can include, one or more of the network devices and modules described herein, e.g., the RU 102, the MC 112, the DU 104, a user device, the CU 106, and/or a cloud computing system.

The computing system includes computing device 1600 and a mobile computing device 1650 that can be used to implement the techniques described herein. For example, either or both of the computing device 1600 and the mobile computing device 1650 can execute one or more neural networks to perform channel estimation, data recovery, scheduling, beamforming weight determination, RF signal analysis, neural network training/retraining, and/or model selection, as described above, e.g., processes 300, 400, 500, 600, 1000, 1100, 1200, 1300, 1400, and/or 1500.

The computing device 1600 is intended to represent various forms of digital computers, such as laptops, desktops, workstations, personal digital assistants, servers, blade servers, mainframes, back-end network equipment, and other appropriate computers. The mobile computing device 1650 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 1600 includes a processor 1602, a memory 1604, a storage device 1606, a high-speed interface 1608 connecting to the memory 1604 and multiple high-speed expansion ports 1610, and a low-speed interface 1612 connecting to a low-speed expansion port 1614 and the storage device 1606. Each of the processor 1602, the memory 1604, the storage device 1606, the high-speed interface 1608, the high-speed expansion ports 1610, and the low-speed interface 1612, are interconnected using various busses, and may be mounted on a common motherboard or in other manners as appropriate. The processor 1602 can process instructions for execution within the computing device 1600, including instructions stored in the memory 1604 or on the storage device 1606 to display graphical information for a GUI on an external input/output device, such as a display 1616 coupled to the high-speed interface 1608. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 1602 is a single-threaded processor. In some implementations, the processor 1602 is a multi-threaded processor. In some implementations, the processor 1602 is a quantum computer.

The memory 1604 stores information within the computing device 1600. In some implementations, the memory 1604 is a volatile memory unit or units. In some implementations, the memory 1604 is a non-volatile memory unit or units. The memory 1604 may also be another form of computer-readable medium, such as a magnetic or optical disk.

The storage device 1606 is capable of providing mass storage for the computing device 1600. In some implementations, the storage device 1606 is or includes a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 1602), perform one or more methods, such as those described above. The instructions can also be stored by one or more storage devices such as computer- or machine-readable mediums (for example, the memory 1604, the storage device 1606, or memory on the processor 1602). The high-speed interface 1608 manages bandwidth-intensive operations for the computing device 1600, while the low-speed interface 1612 manages lower bandwidth-intensive operations. Such allocation of functions is an example only. In some implementations, the high-speed interface 1608 is coupled to the memory 1604, the display 1616 (e.g., through a graphics processor or accelerator), and to the high-speed expansion ports 1610, which may accept various expansion cards (not shown). In the implementation, the low-speed interface 1612 is coupled to the storage device 1606 and the low-speed expansion port 1614. The low-speed expansion port 1614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1600 may be implemented in a number of different forms, as shown in the figure. For example, it may be implemented as a standard server 1620, or multiple times in a group of such servers. In addition, it may be implemented in a personal computer such as a laptop computer 1622. It may also be implemented as part of a rack server system 1624. Alternatively, components from the computing device 1600 may be combined with other components in a mobile device (not shown), such as a mobile computing device 1650. Each of such devices may include one or more of the computing device 1600 and the mobile computing device 1650, and an entire system may be made up of multiple computing devices communicating with each other.

The mobile computing device 1650 includes a processor 1652, a memory 1664, an input/output device such as a display 1654, a communication interface 1666, and a transceiver 1668, among other components. The mobile computing device 1650 may also be provided with a storage device, such as a micro-drive or other device, to provide additional storage. Each of the processor 1652, the memory 1664, the display 1654, the communication interface 1666, and the transceiver 1668, are interconnected using various buses, and several of the components may be mounted on a common motherboard or in other manners as appropriate.

The processor 1652 can execute instructions within the mobile computing device 1650, including instructions stored in the memory 1664. The processor 1652 may be implemented as a chipset of chips that include separate and multiple analog and digital processors. The processor 1652 may provide, for example, for coordination of the other components of the mobile computing device 1650, such as control of user interfaces, applications run by the mobile computing device 1650, and wireless communication by the mobile computing device 1650.

The processor 1652 may communicate with a user through a control interface 1658 and a display interface 1656 coupled to the display 1654. The display 1654 may be, for example, a TFT (Thin-Film-Transistor Liquid Crystal Display) display or an OLED (Organic Light Emitting Diode) display, or other appropriate display technology. The display interface 1656 may include appropriate circuitry for driving the display 1654 to present graphical and other information to a user. The control interface 1658 may receive commands from a user and convert them for submission to the processor 1652. In addition, an external interface 1662 may provide communication with the processor 1652, so as to enable near area communication of the mobile computing device 1650 with other devices. The external interface 1662 may provide, for example, for wired communication in some implementations, or for wireless communication in other implementations, and multiple interfaces may also be used.

The memory 1664 stores information within the mobile computing device 1650. The memory 1664 can be implemented as one or more of a computer-readable medium or media, a volatile memory unit or units, or a non-volatile memory unit or units. An expansion memory 1674 may also be provided and connected to the mobile computing device 1650 through an expansion interface 1672, which may include, for example, a SIMM (Single In Line Memory Module) card interface. The expansion memory 1674 may provide extra storage space for the mobile computing device 1650, or may also store applications or other information for the mobile computing device 1650. Specifically, the expansion memory 1674 may include instructions to carry out or supplement the processes described above, and may include secure information also. Thus, for example, the expansion memory 1674 may be provide as a security module for the mobile computing device 1650, and may be programmed with instructions that permit secure use of the mobile computing device 1650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier such that the instructions, when executed by one or more processing devices (for example, processor 1652), perform one or more methods, such as those described above. The instructions can also be stored by one or more storage devices, such as one or more computer- or machine-readable mediums (for example, the memory 1664, the expansion memory 1674, or memory on the processor 1652). In some implementations, the instructions are received in a propagated signal, for example, over the transceiver 1668 or the external interface 1662.

The mobile computing device 1650 may communicate wirelessly through the communication interface 1666 (e.g., with the computing device 1600), which may include digital signal processing circuitry where appropriate. The communication interface 1666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 1668 using a radio frequency. In addition, short-range communication may occur, such as using a Bluetooth, Wi-Fi, or other such transceiver (not shown). In addition, a GPS (Global Positioning System) receiver module 1670 may provide additional navigation- and location-related wireless data to the mobile computing device 1650, which may be used as appropriate by applications running on the mobile computing device 1650.

The mobile computing device 1650 may also communicate audibly using an audio codec 1660, which may receive spoken information from a user and convert it to usable digital information. The audio codec 1660 may likewise generate audible sound for a user, such as through a speaker, e.g., in a handset of the mobile computing device 1650. Such sound may include sound from voice telephone calls, may include recorded sound (e.g., voice messages, music files, etc.) and may also include sound generated by applications operating on the mobile computing device 1650.

The mobile computing device 1650 may be implemented in a number of different forms, as shown in the figure. For example, it may be implemented as a cellular telephone 1680. It may also be implemented as part of a smart-phone 1682, personal digital assistant, or other similar mobile device.

The term “system” as used in this disclosure may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server is a general-purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A number of implementations have been described. Nevertheless, it will be understood that various modifications may be made. For example, although various examples have been described in reference to cellular networks (e.g., cellular RAN architectures such as vRAN/O-RAN), the described systems and processes can be deployed in various other network contexts, such as Wi-Fi, Bluetooth, wireless LANs, Internet of Things (IoT), and/or other RF environments. As another example, although neural network-based architectures are described for various implementations, the scope of this disclosure includes the same architectures in which “neural network” is replaced with “machine learning network” or “machine learning model” for every implementation described herein (e.g., the implementations of each of FIGS. 1-15). The use of machine learning networks in general (as opposed to neural networks specifically) can provide some or all of the advantages discussed with respect to neural networks, including, for example, the capability to incorporate additional inputs compared to algorithmic approaches, the ability to train/retrain based on sparse training data, the ability to retrain based on real-world data/results, and the ability to select between different machine learning models based on different conditions. Types of machine learning models within the scope of this disclosure include, for example, machine learning models that implement supervised, semi-supervised, unsupervised and/or reinforcement learning; neural networks, including deep neural networks, autoencoders, convolution neural networks, multi-layer perceptron networks, and recurrent neural networks; classification models; and regression models. The machine learning models described herein can be configured with one or more approaches, such as back-propagation, gradient boosted trees, decision trees, support vector machines, reinforcement learning, partially observable Markov decision processes (POMDP), and/or table-based approximation, to provide several non-limiting examples.

In addition, elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method, comprising:
obtaining, by a computer system, samples of radio-frequency (RF) uplink data signals received wirelessly at a radio unit of a radio access network;
providing, by the computer system, the samples of the RF uplink data signals as input to at least one machine learning model;
in response to providing the samples of the RF uplink data signals as input to the at least one machine learning model, obtaining, by the computer system, based on an output of the at least one machine learning model, recovered data of the RF uplink data signals; and
sending, by the computer system, the recovered data of the RF uplink signals to a destination device.

2. The method of claim 1, wherein sending the recovered data of the RF uplink signals to the destination device comprises sending the recovered data of the RF uplink signals to one or more computer systems external to the radio access network.

3. The method of claim 1, further comprising:
receiving, at the computer system, downlink data for a user device in response to sending the recovered data of the RF uplink signals to the destination device; and
controlling, by the computer system, transmission of an RF data downlink signal from the radio unit to the user device, the RF data downlink signal encoding the downlink data.

4. The method of claim 1, wherein the at least one machine learning model comprises:
a first machine learning model configured to perform channel estimation based on the samples of the RF uplink data signals; and
a second machine learning model configured to perform symbol-demapping on estimated symbols of the RF uplink data signals, wherein the estimated symbols are based on the channel estimation by the first machine learning model.

5. The method of claim 4, wherein providing the samples of the RF uplink data signals as input to the at least one machine learning model comprises:
providing the samples of the RF uplink data signals as input to the first machine learning model;
obtaining, as an output of the first machine learning model, channel estimates characterizing channel effects on the RF uplink data signals;
transforming the samples of the RF uplink data signals based on the channel estimates;
providing the transformed samples of the RF uplink data signals as input to the second machine learning model; and
obtaining, as an output of the second machine learning model, data indicative of the recovered data.

6. The method of claim 5, wherein the channel estimates comprise a channel tensor.

7. The method of claim 5, wherein the data indicative of the recovered data comprises inferred bits.

8. The method of claim 4, comprising training the first machine learning model and the second machine learning model in a joint training process,
wherein training data in the joint training process comprises RF resource grids, and
wherein labels for the training data includes ground-truth inferred bits corresponding to the RF resource grids or ground-truth recovered data corresponding to the RF resource grids.

9. The method of claim 1, wherein the at least one machine learning model is configured to receive inputs of varying sizes.

10. The method of claim 9, wherein the at least one machine learning model comprises a fully convolutional neural network.

11. The method of claim 1, wherein the samples of the RF uplink data signals are provided as input in an orthogonal frequency division multiplexing (OFDM) resource grid form.

12. The method of claim 11, wherein the samples of the RF uplink data signals comprise a subset of an uplink resource grid, the subset corresponding to an RF signal burst received from a user device.

13. The method of claim 1, comprising executing the at least one machine learning model in an L1 layer of a distributed unit (DU).

14. The method of claim 1, comprising training a first machine learning model of the at least one machine learning model, wherein the training comprises adjusting weights and parameters of the first machine learning model based on a loss function, wherein the loss function is based on a comparison of (i) pilot values in uplink resource grids and (ii) ground truth values corresponding to the pilot values.

15. The method of claim 1, comprising training a first machine learning model of the at least one machine learning model, wherein the training comprises adjusting weights and parameters of the first machine learning model based on a loss function, wherein the loss function is based on a comparison of (i) data values in uplink resource grids and (ii) ground truth values corresponding to the data values.

16. The method of claim 15, comprising simulating channel effects on the ground truth values, to obtain the data values as simulated pilot values.

17. The method of claim 1, wherein the at least one machine learning model is configured to perform patch-based processing of the samples of the RF uplink data signals.

18. The method of claim 1, wherein the at least one machine learning model has an architecture that includes at least one of:
a non-batch norm, or
a Smooth ReLU activation function.

19. A computer system, comprising:
one or more processors, and
one or more non-transitory, computer-readable storage media storing instructions that, when executed by the one or more processors, cause the one or more processors to perform operations comprising:
obtaining samples of radio-frequency (RF) uplink data signals received wirelessly at a radio unit of a radio access network, the RF uplink data signals including a first RF uplink data signal received from a user device;
providing the samples of the RF uplink data signals as input to at least one machine learning model;
in response to providing the samples of the RF uplink data signals as input to the at least one machine learning model, obtaining based on an output of the at least one machine learning model, recovered data of the RF uplink data signals; and
sending the recovered data of the RF uplink signals to a destination device.

20. One or more non-transitory, computer-readable storage media storing instructions that, when executed by one or more processors, cause the one or more processors to perform operations comprising:
obtaining samples of radio-frequency (RF) uplink data signals received wirelessly at a radio unit of a radio access network, the RF uplink data signals including a first RF uplink data signal received from a user device;
providing the samples of the RF uplink data signals as input to at least one machine learning model;
in response to providing the samples of the RF uplink data signals as input to the at least one machine learning model, obtaining based on an output of the at least one machine learning model, recovered data of the RF uplink data signals; and
sending the recovered data of the RF uplink signals to a destination device.

21.-51. (canceled)
